(19) United States
(12) Patent Application Publication
(10) Pub. No.: US 2022/0081509 A1
(43) Pub. Date: Mar. 17, 2022

(54) A COMPOSITION COMPRISING METHYLENE MALONATE MONOMER AND POLYMER, THE PREPARATION THEREOF AND USE OF THE SAME IN UNDERGROUND CONSTRUCTIONS

(71) Applicant: BASF SE, Ludwigshafen am Rhein (DE)

(72) Inventors: Lei MENG, Shanghai (CN); ShengZhong ZHOU, Shanghai (CN); Harald ROECKEL, Muenster (DE)

(21) Appl. No.: 17/430,897

(22) PCT Filed: Feb. 5, 2020
(86) PCT No.: PCT/EP2020/052849

§ 371 Date: Aug. 13, 2021

(30) Foreign Application Priority Data
Feb. 13, 2019 (CN) PCT/CN2019/074955

(51) Int. Cl. C08G 63/52; C08K 5/42; C08G 63/91; C08K 5/098; C08K 5/00

(52) U.S. Cl. CPC C08G 63/52; C08K 5/42; C08K 5/0025; C08K 5/098; C08G 63/918

(57) ABSTRACT

The present invention relates to a composition comprising methylene malonate monomer and polymer and its use in construction field. Particularly, the invention relates to a composition comprising Component I comprising at least one methylene malonate monomer (A), at least one polymer (B) and at least one acidic stabilizer (C), and Component II comprising at least one alkali accelerator, to the preparation thereof, and to the use of the composition as a protective and/or reinforcement material, particularly used in underground constructions.

### TECHNICAL FIELD

The present invention relates to a composition comprising methylene malonate monomer and polymer and its use in construction field. Particularly, the invention relates to a two-component composition comprising Component I comprising at least one methylene malonate monomer (A), at least one methylene malonate polymer (B) and at least one acidic stabilizer (C), and Component II comprising at least one alkali accelerator, to the preparation thereof, and to the use of the two-component composition as a protective and/or reinforcement material, particularly for underground constructions.

### BACKGROUND

Underground construction refers to various construction activities performed in sub-surface locations and usually involves excavation of rocks, soils, ores, gems, salts, oil sands and the like. Underground construction may comprise such steps as blasting and removing blasted materials, removing unstable slabs or rocks from the roof and sidewalls, applying protective and/or reinforcement materials, drilling face rock, and further rounds of such steps. Exemplary underground constructions are mines, wells, tunnels, subways and the like. Underground construction methodologies are also essential for building constructions such as commercial, residential, industrial or scientific property developments. Depending on the size and nature of the building, it can range from a simple basement to a complex underground facility engineering operation such as underground waste storage facilities, or even a particle accelerator complex. It could also include the option to build a site that is completely underground.

Protective and/or reinforcement materials are applied to the surface and/or to the body of walls to support, protect and/or reinforce the newly excavated roof or sidewalls before, during and/or after the excavation in order to address various challenges workers need to face in underground constructions.

One of the problems is the ingression of water and/or gas via cracks in the surrounding rocks, which usually escalates costs and causes significant delays. To seal against water and gas seepage, a waterproof chemical formulation can be injected with pressure into a structure with the goal of filling cracks and porosity, and eventually stopping water and gas. The injection can be executed either before or after the excavation in front of the tunnel face or behind the tunnel face, respectively, which will create a protective bulkhead between the workers and the water.

Another problem is the damage, erosion or oxidation of existing tunnels, which would lead to rock slabbing or side wall degradation, especially in weak strata. To protect the rock and strata from weathering and to maintain a good working condition of the tunnel surface, it is common to apply a protective layer, such as masonry, brickwork lining or concrete lining to protect, repair and/or renovate the damaged or eroded surface. Such protective layer will be directly applied on the surface of the substrate, such as rock, which is generally without pretreatment and appears uneven, pointed and even wet. Therefore, it is expected that the protective layer should have good bonding property and adhere strongly to the substrate, even without pre-treatment.

A third problem is the cracking or fracturing of the rock strata under stress, especially those caused by localized overburden pressure or uneven rock stress distribution. Conditions can vary from hard and compact rock to a soil-based ground or heavily fragmented substrate. Cracking or fracturing can lead to severe consequences such as roof sinking, rib movement, floor heaving, or tunnel collapse etc. Therefore, it is important to apply a reinforcement material that can progressively increase tensile strength and hardness during curing, preferably within a short period of time, so as to provide sufficient mechanical support to the side walls.

For many years, there has been an on-going development of polymer-based formulations for the protection and/or reinforcement of such walls. By bonding with substrates, including concrete and rock, polymers can be used for sealing of substrate, stabilization of rock, preliminary slope protection, preliminary and temporary in-cycle support and protection against rock weathering and waterproofing. Compared to other civil engineering projects that are performed above the ground, underground constructions are performed in a closed or partially closed space with bad ventilation. Hazardous gases and/or dust are frequently created from blasting and drilling activities, equipment operation, or from gas naturally emanating from the rock (eg. radon gas). Therefore, it is critical to use formulations with low or substantially no volatile organic compounds (VOC) and poisonous ingredient. Reactive resins such as polyurethane and polyurea silicate resins are currently used in underground constructions because of their excellent bonding and mechanical performance. However, these resins are toxic and environmentally unfriendly, especially the monomer of polyurethane, i.e. isocyanate. Other resins like unsaturated polyester and polyacrylate use explosive peroxide as the initiator for polymerization and also have the problem of strong pungent odor. Besides, harmful solvents are sometimes used to decrease the viscosity of polyacrylate. It is therefore anticipated that their use would be greatly influenced and restricted by the increasingly strict safety regulations.

Another preferred quality of protective and/or reinforcement materials applied during underground constructions is a fast curing speed and a fast strength build-up profile. Cracking or fracturing of walls, often happening imminently and unexpectedly after excavation, calls for the use of fast-setting polymers to offer a timely and effective support. They are coated onto the surface or injected into the structure, set to a tack-free state and gain strength over the subsequent hours, days and sometime even weeks. They are expected to provide supplementary support to strategic areas of the underground construction where people and critical infrastructure are often present. In this regard, polyurethane is disadvantageous because of the long curing time, especially at low temperature or under high humidity.

Moreover, underground constructions often take place in complicated environments with fluctuations in temperature, humidity and oxygen levels. In this regard, currently used polyacrylate is sensitive to oxygen, i.e. oxygen hinders the curing, which tends to make the finished surface greasy or tacky. Therefore, a polymer that can be cured within a wide range of temperature, humidity and oxygen levels is preferred.

Therefore, it is expected in the underground construction field to provide a composition used as a protective and/or reinforcement material that is free of VOC and poisonous ingredient, simple for handling, fast curing in a wide range of temperature, humidity and oxygen levels, quick strength build-up, and, at the same time, has expected performances including good waterproofing, bonding and mechanical properties.

### SUMMARY OF THE PRESENT INVENTION

An object of this invention is to provide a composition which, when used in underground constructions, does not have the above deficiencies in the prior art. Particularly, an object of this invention is to provide a novel composition, wherein the methylene malonate monomer and the polymer thereof are mixed in a specific ratio. Such a composition can undergo fast curing with carefully selected acidic additives and alkali accelerators, and can be applied in an extreme condition, such as at a low temperature and a high humidity level, and thus is suitable for use in underground constructions. The resulting cured product is substantially a 100% solid compound with little or substantially no VOC, and shows excellent performances in terms of early hardness, curing speed, bonding strength, tensile strength and elongation, and the like.

Surprisingly, it has been found by the inventors that the above objects can be achieved by a two-component composition comprising:

(1) Component I comprising:
(A) at least one methylene malonate monomer having formula (I),

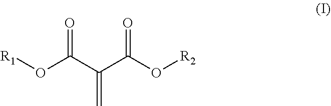

wherein R₁ and R₂ are in each case independently selected from the group consisting of C1-C15-alkyl, C2-C15-alkenyl, C3-C15-cyclolalkyl, C2-C15-heterocyclyl, C2-C15-heterocyclyl-(C1-C15-alkyl), C6-C15-aryl, C6-C15-aryl-C1-C15-alkyl, C2-C15-heteroaryl, C2-C15-heteroaryl-C1-C15-alkyl, C1-C15-alkoxy-C1-C15-alkyl, halo-C1-C15-alkyl, halo-C2-C15-alkenyl, and halo-C3-C15-cyclolalkyl, each of which radicals is optionally substituted, the heteroatom being selected from N, O and S;
(B) at least one methylene malonate polymer having formula (II),

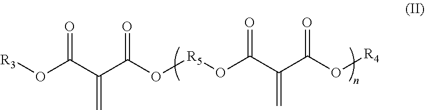

wherein, R₃ and R₄ are, in each case independently selected from the group consisting of C1-C15-alkyl, C2-C15-alkenyl, C3-C15-cyclolalkyl, C2-C15-heterocyclyl, C2-C15-heterocyclyl-(C1-C15-alkyl), C6-C15-aryl, C6-C15-aryl-C1-C15-alkyl, C2-C15-heteroaryl, C2-C15-heteroaryl-C1-C15-alkyl, C1-C15-alkoxy-C1-C15-alkyl, halo-C1-C15-alkyl, halo-C1-C15-alkenyl, and halo-C3-C15-cyclolalkyl, each of which radicals is optionally substituted, the heteroatom being selected from N, O and S;
n is an integer from 1 to 20;
R₅, if n=1 is, or if n>1 are in each case independently, selected from the group consisting of C1-C15-alkylene, C2-C15-alkenylene, C2-C15-alkynylene, C6-C15-arylene, C3-C15-cyclolalkylene, C5-C15-cyclolalkenylene, C5-C15-cyclolalkynylene, C2-C15-heterocyclylene, and C2-C15-heteroarylene, each of which radicals is optionally substituted, the heteroatom being selected from N, O and S, wherein R₅ is optionally interrupted by a radical selected from N, O and S; and
(C) at least one acidic stabilizer; and
(2) Component II comprising at least one alkali accelerator;
wherein, the monomer (A) is in an amount of from 0 to 40 wt. %, preferably from 0 to 30 wt. % and more preferably from 0 to 20 wt. %, and most preferably 0 to 10 wt. %, in each case based on the total weight of the monomer (A) and the polymer (B);
the acidic stabilizer (C) is in an amount of from 0.1 to 500 ppm, preferably from 0.1 to 300 ppm and more preferably from 0.1 to 200 ppm, and most preferably from 0.1 to 100 ppm;
the Component II is in an amount of from 0.03 to 100 wt. % based on the total weight of the monomer (A) and the polymer (B); and
starting from mixing Component I and Component II, the Shore D hardness of the composition after m hours Hₜ₌ₘ should satisfy the condition: Hₜ₌₂₄ is no less than 70, preferably Hₜ₌₅≥80%*Hₜ=₂₄, more preferably Hₜ₌₃≥70%*Hₜ₌₂₄, even more preferably Hₜ₌₂≥50%*Hₜ₌₂₄. Generally for the purpose of this invention, Shore D hardness is preferably determined according to DIN53505.

In a further aspect, the invention relates to a mixture comprising the two-component composition according to the invention.

The two-component composition may be prepared by a process comprising steps of:

(1) mixing the monomer (A), the polymer (B) and the acidic stabilizer (C) to obtain the Component I;
(2) preparing the Component II; and
(3) mixing the Component I and the Component II to obtain the composition.

It has been surprisingly found that the two-component composition or the mixture according to this invention can be cured and can achieve satisfactory hardness within a short period of time. It's also found that the composition or the mixture can be cured even at a low temperature below 0° C. and at a high humidity level. The cured composition or mixture thus-obtained exhibits sufficient bonding strength, tensile strength, flexibility, and waterproofing ability, thus are suitable as a protective and/or reinforcement material in the underground construction field.

In a still further aspect, the invention relates to the use of the two-component composition or the mixture according to the invention in underground constructions.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, the term “methylene malonate” refers to a compound having the core formula —O—C(O)—C(═CH₂)—C(O)—O—.

As used herein, the term “two-component” refers to a composition comprising two components, each of which may also be a mixture of several compounds. The two components can be blended together if needed. And the two components may also be two independent packages that can be mixed on the spot for applications.

As used herein, the term “RH” is equal to “Relative Humidity” and refers to the ratio of the partial vapor pressure of water to the saturated vapor pressure of water at a given temperature.

As used herein, the term “substantially absence” as in “substantially absence of the solvent” refers to a reaction mixture which comprises less than 1% by weight of the particular component as compared to the total reaction mixture. In certain embodiments, the “substantial absence” refers to less than 0.7%, less than 0.5%, less than 0.4%, less than 0.3%, less than 0.2% or less than 0.1% by weight of the particular component as compared to the total reaction mixture. In certain other embodiments, the “substantial absence” refers to less than 1.0%, less than 0.7%, less than 0.5%, less than 0.4%, less than 0.3%, less than 0.2% or less than 0.1% by volume of the particular component as compared to the total reaction mixture.

As used herein, the term “stabilized,” e.g., in the context of “stabilized” monomers of the invention or compositions comprising the same, refers to the tendency of the monomers of the invention (or their compositions) to substantially not polymerize with time, to substantially not harden, form a gel, thicken, or otherwise increase in viscosity with time, and/or to substantially show minimal loss in cure speed (i.e., cure speed is maintained) with time as compared to similar compositions that are not stabilized.

As used herein, the term “shelf-life,” e.g., as in the context of the compositions of the invention having an improved “shelf-life,” refers to the compositions of the invention which are stabilized for a given period of time, e.g., 1 month, 6 months, or even 1 year or more.

As used herein, the term “additives” refers to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, defoaming agents, surfactants, wetting agents, dispersants, flow or slip aids, biocides, and stabilizers.

As used herein, the term “base” refers to a component having at least one electronegative group capable of initiating anionic polymerization.

As used herein the term “base precursor” refers to a component that may be converted to a base upon being acted upon in some manner, e.g., application of heat, chemical reaction, or UV activation.

As used herein, the term “base enhancer” refers to an agent that is capable of acting in some manner to improve or enhance the basicity of an agent.

As used herein, the term “halogen atom”, “halogen”, “halo-” or “Hal-” is to be understood as meaning a fluorine, chlorine, bromine or iodine atom.

As used herein, the term “alkyl”, either on its own or else in combination with further terms, for example haloalkyl, is understood as meaning a radical of a saturated aliphatic hydrocarbon group and may be branched or unbranched, for example methyl, ethyl, propyl, butyl, isobutyl, pentyl, hexyl, heptyl, octyl, nonyl, decyl, undecyl or dodecyl, or an isomer thereof.

As used herein, the term “alkenyl”, either on its own or else in combination with further terms, for example haloalkenyl, is understood as meaning a straight-chain or branched radical which has at least one double bond, for example vinyl, allyl, propenyl, butenyl, butadienyl, pentenyl, pentadienyl, hexenyl, or hexadienyl, or an isomer thereof.

As used herein, the term “alkynyl”, either on its own or else in combination with further terms, for example haloalkynyl, is understood as meaning a straight-chain or branched radical which has at least one triple bond, for example ethynyl, propynyl, or propargyl, or an isomer thereof.

As used herein, the term “cycloalkyl”, either on its own or else in combination with further terms, is understood as meaning a fused or non-fused, saturated, monocyclic or polycyclic hydrocarbon ring, for example cyclopropyl, cyclobutyl, cyclopentyl, cyclohexyl, cycloheptyl, or cyclooctyl, or an isomer thereof.

As used herein, the term “alkoxy”, either on its own or else in combination with further terms, for example haloalkoxy, is understood as meaning linear or branched, saturated, group having a formula —O-alkyl, in which the term “alkyl” is as defined above, for example methoxy, ethoxy, propoxy, butoxy, pentoxy, or hexoxy, or an isomer thereof.

As used herein, the term “aryl”, either on its own or else in combination with further terms, for example arylalkyl, is understood to include fused or non-fused aryl, such as phenyl or naphthyl, wherein phenyl is optionally substituted by 1 to 5 groups, and naphtyl is optionally substituted by 1 to 7 groups.

As used herein, the term “hetero-” is understood as meaning a saturated or unsaturated radical which is interrupted by at least one heteroatom selected from the group consisting of oxygen (O), nitrogen (N), and sulphur (S).

As used herein, the term “A- to B-member hetero-”, for example “3- to 6-member hetero-”, is understood as meaning a fused or non-fused, saturated or unsaturated monocyclic or polycyclic radical comprising, in addition to carbon atom, at least one heteroatom selected from the group consisting of oxygen (O), nitrogen (N), and sulphur (S), provided that the sum of the number of carbon atom and the number of heteroatom is within the range of A to B. The hetero groups according to this invention are preferably 5- to 30-member hetero groups, most preferably 6- to 18-member hetero groups, especially 6- to 12-member hetero groups, and particularly 6- to 8-member hetero groups.

As used herein, the term “heterocyclyl” is understood as including aliphatic or aromatic heterocyclyl, for example heterocyclylalkyl or heterocyclylalkenyl.

The term “substituted” means that one or more hydrogens on the designated atom is replaced with a selection from the indicated group, provided that the designated atom's normal valency under the existing circumstances is not exceeded, and that the substitution results in a stable compound. Combinations of substituents and/or variables are permissible only if such combinations result in stable compounds.

The term “optionally substituted” means optional substitution with the specified groups, radicals or moieties. Unless stated otherwise, optionally substituted radicals may be mono- or polysubstituted, where the substituents in the case of polysubstitution may be the same or different.

As used herein, halogen-substituted radicals, for example haloalkyl, are mono- or polyhalogenated, up to the maximum number of possible substituents. In the case of polyhalogenation, the halogen atoms can be identical or different. In this case, halogen is fluorine, chlorine, bromine or iodine.

As used herein, the groups with suffix “-ene” represent the groups have two covalent bond which could be linked to other radicals, for example —CH₂CH(CH₃)CH₂-(isobutylene),

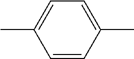

(phenylene), and in the case of phenylene, the covalent bond may be located in ortho-, meta-, or para-position.

Unless otherwise identified, all percentages (%) are “percent by weight”.

The radical definitions or elucidations given above in general terms or within areas of preference apply to the end products and correspondingly to the starting materials and intermediates. These radical definitions can be combined with one another as desired, i.e. including combinations between the general definition and/or the respective ranges of preference and/or the embodiments.

Unless otherwise identified, the temperature refers to room temperature and the pressure refers to ambient pressure.

Unless otherwise identified, the solvent refers to all organic and inorganic solvents known to the persons skilled in the art, including water, and does not include any type of monomer molecule.

In one aspect, the invention provides a two-component composition comprising:

(1) Component I comprising:
(A) at least one methylene malonate monomer having formula (I),

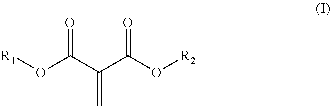

wherein R₁ and R₂ are in each case independently selected from the group consisting of C1-C15-alkyl, C2-C15-alkenyl, C3-C15-cyclolalkyl, C2-C15-heterocyclyl, C2-C15-heterocyclyl-C1-C15-alkyl, C6-C15-aryl, C6-C15-aryl-(C1-C15-alkyl), C2-C15-heteroaryl, C2-C15-heteroaryl-C1-C15-alkyl, C1-C15-alkoxy-C1-C15-alkyl, halo-C1-C15-alkyl, halo-C2-C15-alkenyl, and halo-C3-C15-cyclolalkyl, each of which radicals is optionally substituted, the heteroatom being selected from N, O and S;
(B) at least one methylene malonate polymer having formula (II),

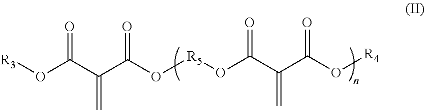

wherein C1-C15-alkyl, C2-C15-alkenyl, C3-C15-cyclolalkyl, C2-C15-heterocyclyl, C2-C15-heterocyclyl-C1-C15-alkyl, C6-C15-aryl, C6-C15-aryl-(C1-C15-alkyl), C2-C15-heteroaryl, C2-C15-heteroaryl-C1-C15-alkyl, C1-C15-alkoxy-C1-C15-alkyl, halo-C1-C15-alkyl, halo-C2-C15-alkenyl, and halo-C3-C15-cyclolalkyl, each of which radicals is optionally substituted, the heteroatom being selected from N, O and S;
n is an integer from 1 to 20;
R₅, if n=1 is, or if n>1 are in each case independently, selected from the group consisting of C1-C15-alkylene, C2-C15-alkenylene, C2-C15-alkynylene, C6-C15-arylene, C3-C15-cyclolalkylene, C5-C15-cyclolalkenylene, C5-C15-cyclolalkynylene, C2-C15-heterocyclylene, and C2-C15-heteroarylene, each of which radicals is optionally substituted, and the heteroatom being selected from N, O and S, wherein R₅ is optionally interrupted by a radical selected from N, O and S; and
(C) at least one acidic stabilizer; and
(2) Component II comprising at least one alkali accelerator,
wherein, the monomer (A) is in an amount of from 0 to 40 wt. %, preferably from 0 to 30 wt. % and more preferably from 0 to 20 wt. %, and most preferably 0 to 10 wt. %, in each case based on the total weight of the monomer (A) and the polymer (B); the acidic stabilizer (C) is in an amount of from 0.1 to 500 ppm, preferably from 0.1 to 300 ppm and more preferably from 0.1 to 200 ppm, and most preferably from 0.1 to 100 ppm;
and
the Component II is in an amount of from 0.03 to 100 wt. % based on the total weight of the monomer (A) and the polymer (B); and
starting from mixing Component I and Component II, the composition's Shore D hardness after 24 hours is no less than 70.

In a preferred embodiment of the invention, starting from mixing Component I and Component II, the composition's Shore D hardness after 5 hours is no less than 80% of its Shore D hardness after 24 hours, preferably no less than 90%.

In a preferred embodiment of the invention, starting from mixing Component I and Component II, the composition's Shore D hardness after 3 hours is no less than 70% of its Shore D hardness after 24 hours, preferably no less than 80%.

In a preferred embodiment of the invention, starting from mixing Component I and Component II, the composition's Shore D hardness after 2 hours is no less than 50% of its Shore D hardness after 24 hours, preferably no less than 60%, more preferably no less than 70%.

In one embodiment of the invention, the cured composition has a tensile strength of no less than 7 Mpa, preferably no less than 8 Mpa, more preferably no less than 9 Mpa, and most preferably no less than 10 Mpa, and an elongation rate of no less than 1%, preferably no less than 1.5%, more preferably no less than 2%, and most preferably no less than 3%. Generally for the purpose of this invention, the tensile strength and elongation rate are each determined according to DIN 53504.

In one embodiment of the invention, the composition has an adhesive bonding with the substrate of no less than 2 N/mm², preferably no less than 3 N/mm². Generally for the purpose of this invention, the adhesive bonding is determined according to ASTM D7234-12.

In one embodiment of the invention, the composition has a gel time of no more than 30 min, preferably no more than 20 min, more preferably no more than 15 min, most preferably no more than 10 min. Generally for the purpose of this invention, gel time is determined according to the method described in the Measurement Methods.

In a preferred embodiment of the invention, R₁ and R₂ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C18-aryl, C6-C18-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C15-alkenyl and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

Preferably, R₁ and R₂ are in each case independently selected from the group consisting of C1-C6-alkyl, C2-C6-alkenyl, C3-C6-cyclolalkyl, C3-C6-heterocyclyl, C3-C6-heterocyclyl-C1-C6-alkyl, C6-C8-aryl, C6-C8-aryl-C1-C6-alkyl, C2-C8-heteroaryl, C2-C8-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkynyl, the heteroatom being selected from N, O and S.

More preferably, R₁ and R₂ are in each case independently selected from the group consisting of C1-C6-alkyl and C3-C6-cyclolalkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl, cyclopropyl, cyclobutyl, cyclopentyl, cyclohexyl.

More preferably, R₁ and R₂ are in each case independently selected from the group consisting of linear C1-C6-alkyl and C3-C6-cyclolalkyl, for example methyl, ethyl, n-propyl, n-butyl, n-pentyl, n-hexyl, cyclohexyl.

In a preferred embodiment of the invention, R₃ and R₄ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C10-aryl, C6-C10-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C10-alkenyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

Preferably, R₃ and R₄ are in each case independently selected from the group consisting of C1-C6-alkyl, C2-C6-alkenyl, C3-C6-cyclolalkyl, C3-C6-heterocyclyl, C33-C6-heterocyclyl-C1-C6-alkyl, C6-C8-aryl, C6-C8-aryl-C1-C6-alkyl, C2-C8-heteroaryl, C2-C8-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkynyl, the heteroatom being selected from N, O and S.

More preferably, R₃ and R₄ are in each case independently selected from the group consisting of C1-C6-alkyl, for example methyl, ethyl, n- or isopropyl, n-, iso-, tert- or 2-butyl, pentyls such as n-pentyl and isopentyl, hexyls such as n-hexyl, isohexyl and 1,3-dimethylbutyl.

More preferably, R₃ and R₄ are in each case independently selected from the group consisting of linear C1-C6-alkyl, for example methyl, ethyl, n-propyl, n-butyl, n-pentyl, n-hexyl.

In a preferred embodiment of the invention, R₁, R₂, R₃ and R₄ are the same.

In a preferred embodiment of the invention, n is from 1 to 15, preferably from 1 to 10, more preferably from 1 to 8.

In a preferred embodiment of the invention, R₅, if n=1 is, or if n>1 are in each case independently, selected from the group consisting of C1-C10-alkylene, C2-C10-alkenylene, C2-C10-alkynylene, C3-C18-arylene, C3-C10-cyclolalkylene, C3-C10-cyclolalkenylene, C3-C10-cyclolalkynylene, C2-C10-heterocyclylene, and C2-C10-heteroarylene, each of which radicals is optionally substituted, the heteroatom being selected from N, O and S, wherein R₅ is optionally interrupted by a radical selected from N, O and S.

Preferably, R₅, if n=1 is, or if n>1 are in each case independently, selected from the group consisting of C1-C6-alkylene, C2-C6-alkenylene, C2-C6-alkynylene, C6-C8-arylene, C3-C6-cyclolalkylene, C5-C6-cyclolalkenylene, C5-C6-cyclolalkynylene, C2-C6-heterocyclylene, and C2-C8-heteroarylene, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkyny, the heteroatom being selected from N, O and S, wherein R₅ is optionally interrupted by a radical selected from N, O and S.

More preferably, R₅, if n=1 is, or if n>1 are in each case independently, selected from the group consisting of C1-C6-alkylene and C6-C8-arylene, each of which radicals is optionally substituted by at least one C1-C6-alkyl.

Most preferably, R₅, if n=1 is, or if n>1 are in each case independently, selected from the group consisting of propylidene, pentylidene and phenylene, each of which radicals is optionally substituted by methyl.

Particularly, R₅ may be phenylene. It can be linked to other radicals in the main chain in its ortho-, meta-, or para-position, preferably para-position, i.e.

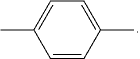

In a preferred embodiment of the invention, the radicals may be further substituted by substituents. Possible substituents may be selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C3-C18-aryl, C3-C18-aryl-C1-C10-alkyl, C2-C10-heteroaryl, C3-C10-cyclolalkenyl, and C3-C10-cyclolalkynyl, wherein the heteroatom is selected from N, O and S.

Preferably, the substituents may be selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C3-C6-heterocyclyl, C3-C6-heterocyclyl-C1-C6-alkyl, halo-C1-C6-alkyl, halo-C3-C6-cyclolalkyl, C6-C8-aryl, C6-C8-aryl-C1-C6-alkyl, C3-C6-heteroaryl, C3-C6-cyclolalkenyl, and C3-C6-cyclolalkynyl, wherein the heteroatom is selected from N, O and S.

Surprisingly, it has been found by the inventors that a suitable amount of the monomer (A) and the polymer (B) or of the respective components in the composition leads to an excellent balance of the properties desired by a construction material used in underground constructions, such as safety, bonding strength, curing speed, tensile strength, hardness, elongation and waterproof, and the like.

In each case, the compositions of the invention shall include one or more compounds to extend the shelf-life. In certain embodiments, the compositions are formulated such that the composition is stable for at least 6 months and preferably, is stable for at least one year. Said compounds comprise acidic stabilizer.

The present invention contemplates any suitable acidic stabilizer known in the art, including, for example, sulfuric acid (H₂SO₄), trifluoromethane sulfonic acid (TFA), chlorodifluoro acid, maleic acid, methane sulfonic acid (MSA), p-toluenesulfonic acid (p-TSA), difluoro acetic acid, trichloroacetic acid, phosphoric acid, dichloroacetic acid or similar acid. Not being limited by the list, acidic stabilizers can include any material that can be added to the compositions containing monomers or polymers to extend shelf-life by up to, for example, 1 year or more. Such acidic stabilizers may have a pKa in the range of, for example, between about −15 to about 5, or between about −15 to about 3, or between about −15 to about 1, or between about −2 to about 2, or between about 2 to about 5, or between about 3 to about 5.

For each of these acidic stabilizing materials, such acidic stabilizer can be present in an amount of from 0.1 to 500 ppm, preferably from 0.1 to 400, more preferably from 0.1 to 300 ppm, much more preferably from 0.1 to 200 ppm, and much more preferably from 0.1 to 100 ppm.

In each case, the compositions of the invention shall further comprise an alkali accelerator.

According to a preferred embodiment of the invention, the alkali accelerator is in a form of a base, a base precursor, or a base enhancer. Preferably, the alkali accelerator is at least one selected from aliphatic monoamines, aliphatic diamines, aliphatic triamines, aliphatic oligomers, aromatic amines, etheramines, hydramines, polyurethane catalysts, morpholines, piperidines, piperazines, pyridines, nitro compounds. Preferably, the alkali accelerator is at least one selected from metal or amine salts of organic lewis acids. Preferably, the alkali accelerator is at least one selected from salts of polymer bound acids, 2,4-pentanedionate, diketones, monocarboxylic acids, polyacrylic acid co-polymers. Preferably, the alkali accelerator is at least one selected from benzoate salts, propionate salts, salts of amine or metal with mineral acids, preferably, halide, silicate, acetate, chloracetate, metal hydroxide, and metal oxide. Said metal is preferably at least one selected from lithium, sodium, potassium, magnesium, calcium, copper, iron, zinc, aluminum, and cobalt etc.

Preferably the alkali accelerator is at least one selected from 2-ethylhexylamine, N-Octylamine, tridecylamine mixture of isomers, 3,3′-dimethyl-4,4′-diaminodicyclohexylmethane, 4,4′-diaminodicyclohexylmethane, isophorone diamine, neopentanediamine (2,2-Dimethylpropane-1,3-diamine), octamethylenediamine, polyetheramine D 2000, polyetheramine D 230, polyetheramine D 400, polyetheramine T 403, polyetheramine T 5000, 4,4′-diaminodiphenylmethane, benzylamine, dibutylethanolamine, di-(2-ethylhexyl)amine, dibutylamine, dicyclohexylamine, ditridecylamine mixture of isomers, 4,9-Dioxadodecane-1,12-diamine, di-(2-methoxyethyl)amine, N,N-dimethylcyclohexylamine, tributylamine, tripropylamine, tris-(2-ethylhexyl)amine, triethylamine, 2-(diisopropylamino)ethylamine, tetramethyl-1,6-hexanediamine, pentamethyldietylenetriamine, bis(2-dimethylaminoethyl) ether, trimethylaminoethylethanolamine, tris(dimethylaminomethyl)phenol, 2-dimethylaminomethylphenol, dimethylethylamine, dimethylpropylamine, N,N-dimethylisopropylamine, N-Ethyldiisopropylamine, trimethylamine, 3-(cyclohexylamino)propylamine, diethylenetriamine, dipropylene triamine, N3-Amine 3-(2-Aminoethylamino)propylamine, N4-Amine N,N′-Bis-(3-Aminopropyl)ethylenediamine, N,N-Bis-(3-aminopropyl)methylamine, 3-(diethylamino)propylamine, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine; 3-dimethylaminopropane-1-ol, dimethylaminoethoxyethanol, diethanol-para-toluidine, diisopropanol-p-toluidine, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene, N-methylmorpholine, 4-(2-hydroxyethyl)morpholine, 2,2′-Dimorpholinodiethylether, 1,8-diazabicyclo-5,4,0-undecene-7, sodium hydroxide, potassium hydroxide, zinc hydroxide, copper hydroxide, magnesium hydroxide, aluminum hydroxide, calcium hydroxide, ferric and ferrous hydroxide, sodium benzoate, lithium chloride, sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, sodium silicate, potassium silicate, zinc silicate, copper silicate, magnesium silicate, iron silicate and aluminum silicate.

Surprisingly, it has been found by the inventors that a suitable amount of the monomer, the polymer and alkali accelerator or of the respective components in the composition leads to an excellent balance of the properties desired by a construction material used in underground constructions, such as safety, curing speed, early strength, bonding strength, tensile strength, elongation etc. The amounts of the monomer, the polymer and alkali accelerator or of the respective components in the composition can be adjusted to accommodate different applications, making the two-component composition a robust product.

According to a preferred embodiment of the invention, the required amount of alkali accelerator may be present in an amount of from 0.03 to 100 wt. %, based on the total weight of the monomer (A) and the polymer (B).

According to one embodiment, the required amount of alkali accelerator may be present in an amount of from 0.03 to 5 wt. %, based on the total weight of the monomer (A) and the polymer (B). Said alkali accelerator is preferably selected from sodium silicate, potassium silicate, zinc silicate, copper silicate, magnesium silicate, aluminum silicate, dimethylethylamine, dimethylpropylamine, N,N-dimethylisopropylamine, N-Ethyldiisopropylamine, N,N-dimethylcyclohexylamine, trimethylamine, triethylamine, tripropylamine, tributylamine, tris-(2-ethylhexyl)amine, 2-(diisopropylamino)ethylamine, tetramethyl-1,6-hexanediamine, S-triazine, pentamethyldietylenetriamine, bis(2-dimethylaminoethyl) ether, N,N-Dimethylcyclohexylamine, bis(2-dimethylaminoethyl)ether, pentamethyldietylenetriamine, trimethylaminoethylethanolamine, tetramethyl-1,6-hexanediamine, tris(dimethylaminomethyl)phenol, 2-dimethylaminomethylphenol, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine; dimethylaminoethoxyethanol, diethanol-para-toluidine, diisopropanol-p-toluidine, 3-dimethylaminopropane-1-ol, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene, lithium chloride, piperidene, piperazine, N-Methylmorpholine, 4-(2-hydroxyethyl)morpholine, 2,2′-Dimorpholinodiethylether, pyridine, and the mixture thereof.

According to one embodiment, the required amount of alkali accelerator may be present in an amount of from 0.5 to 35 wt. %, based on the total weight of the monomer (A) and the polymer (B). Said alkali accelerator is preferably selected from sodium propionate, potassium propionate, zinc propionate, copper propionate, magnesium propionate, aluminum propionate, sodium sorbate, potassium sorbate, zinc sorbate, copper sorbate, magnesium sorbate, aluminum sorbate, sodium benzoate, potassium benzoate, zinc benzoate, copper benzoate, magnesium benzoate, aluminum benzoate, 2-ethylhexylamine, N-Octylamine, tridecylamine, 3,3′-dimethyl-4,4′-diaminodicyclohexylmethane, 4,4′-diaminodicyclohexylmethane, isophorone diamine, neopentanediamine, 2,2-Dimethylpropane-1,3-diamine, octamethylenediamine, dibutylethanolamine, 4,4′-diaminodiphenylmethane, benzylamine, polyetheramine D 2000, polyetheramine D 230, polyetheramine D 400, polyetheramine T 403, polyetheramine T 5000, di-(2-ethylhexyl)amine, dibutylamine, dicyclohexylamine, ditridecylamine, 4,9-Dioxadodecane-1,12-diamine, di-(2-methoxyethyl)amine, 3-(cyclohexylamino)propylamine, diethylenetriamine, dipropylene triamine, N3-Amine (3-(2-Aminoethylamino)propylamine), N4-Amine (N,N′-Bis-(3-Aminopropyl)ethylenediamine), 3-(diethylamino)propylamine, N,N-Bis-(3-aminopropyl)methylamine, diketone, or the mixture thereof.

According to one embodiment, the required amount of alkali accelerator may be present in an amount of from 5 to 100 wt. %, based on the total weight of the monomer (A) and the polymer (B). Said alkali accelerator is preferably selected from sodium hydroxide, potassium hydroxide, zinc hydroxide, copper hydroxide, magnesium hydroxide, aluminum hydroxide, calcium hydroxide, sodium oxide, potassium oxide, zinc oxide, copper oxide, magnesium oxide, aluminum oxide, calcium oxide, sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, ammonium salts, amine salt or the mixture thereof.

According to one embodiment, the required amount of alkali accelerator may be present in an amount of from 0.03-1%, based on the total weight of the monomer (A) and the polymer (B). Said alkali accelerator is preferably selected from lithium chloride, tris(dimethylaminomethyl)phenol, 2-dimethylaminomethylphenol, diethylenetriamine, N,N,N′,N′-Tetrakis(2-hydroxyethyl)ethylenediamine or the mixture thereof.

According to one embodiment, the required amount of alkali accelerator may be present in an amount of from 1-35%, based on the total weight of the monomer (A) and the polymer (B). Said alkali accelerator is preferably selected from sodium propionate, sodium benzoate, 2,2′-Dimorpholinodiethylether or the mixture thereof.

According to one embodiment, the required amount of alkali accelerator may be present in an amount of from 35-100%, based on the total weight of the monomer (A) and the polymer (B). Said alkali accelerator is preferably selected from calcium hydroxide, magnesium oxide, Manganese acetylacetonate, tetrabutyl ammonium chloride, tetrabutyl ammonium hydroxide or the mixture thereof.

According to an embodiment of the invention, the mixture comprises the composition according to the invention.

According to an embodiment of the invention, the mixture comprising the composition according to the invention is substantially absent of any solvent.

According to an embodiment of the invention, the mixture comprising the composition according to the invention may further comprise other additives.

In certain embodiments of the invention, the other additives may be at least one selected from plasticizers, thixotropic agents, adhesion promoters, antioxidants, light stabilizers, UV stabilizer, filler, cement, lime stone, surfactant, wetting agents, viscosity modifier, extenders, dispersants, anti-blocking agents, air release agents, anti-sagging agents, anti-setting agents, matting agents, flattening agents, waxes, anti-mar additives, anti-scratch additives, defoaming agent, or inert resins. In a preferred embodiment of the invention, the additives may be at least one selected from plasticizers, thixotropic agents, adhesion promoters, antioxidants, light stabilizers, UV stabilizer, filler, cement, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins

For those skilled in the art, the above additives are commercially available. The above formulation additives, if any, are presented in an amount commonly used in the art.

In other embodiments of the invention, the mixture comprising the composition according to the invention may further include a coloring agent, including, but not limited to, organic pigment, organo-metallic pigment, mineral-based pigment, carbon pigments, titanium pigment, azo compound, quinacridone compound, phthalocyanine compound, cadmium pigment, chromium pigment, cobalt pigment, copper pigment, iron pigment, clay earth pigment, lead pigment, mercury pigment, titanium pigment, aluminum pigment, manganese pigment, ultramarine pigment, zinc pigment, arsenic pigment, tin pigment, iron oxide pigment, antimonypigment, barium pigment, a biological pigment, dye, photochromic, conductive and liquid crystal polymer pigment, piezochromic pigment, goniochromaticpigment, silver pigment, diketopyrrolo-pyrrole, benzimidazolone, isoindoline, isoindolinone, radio-opacifier and the like.

For those skilled in the art, the above coloring agents are commercially available. The above coloring agents, if any, are presented in an amount commonly used in the art.

The definitions and description concerning the composition also apply to the process and use of the present invention.

The composition according to the invention may be obtained by a process comprising steps of:

(1) mixing the monomer (A), the polymer (B) and the acidic stabilizer (C) to obtain Component I;
(2) preparing the Component II; and
(3) mixing the Component I and the Component II to obtain the composition.

In a preferred embodiment, the process for preparing the composition according to the invention comprises a) mixing the monomer (A) and the polymer (B); b) adding the acidic stabilizer (C) into the mixture obtained from step (a); and c) adding alkali accelerator into the mixture obtained from step (b).

The mixing used in the process is carried out by conventional means in the art in a unit suitable for mixing, for example, by stirring or agitating, using a mixing stick, a IKA mixer or a magnetic stir bar at a room temperature.

According to specific aspects of the invention, the methylene malonate monomer (A) having formula (I) could be prepared by those skilled in the art by means of the following steps: (a) reacting a malonic acid ester with a source of formaldehyde, optionally in the presence of an acidic or basic catalyst, and optionally in the presence of an acidic or non-acidic solvent, to form a reaction mixture; (b) contacting the reaction mixture or a portion thereof with an energy transfer means to produce a vapor phase comprising methylene malonate monomer; and (c) isolating the methylene malonate monomer from the vapor phase.

According to an embodiment of the invention, the methylene malonate polymer (B) having formula (II) could be prepared by those skilled in the art by means of the following steps: An appropriate amount of starting material (e.g., DEMM) and an appropriate amount of OH-containing linking group (e.g. diol) are mixed and reacted in the presence of a catalyst (e.g. Novazym 435), and the resulting mixture is stirred and heated for a period of time at a certain temperature, while the alcohol generated was removed by evaporation. Subsequently, the reaction mixture is cooled and stabilized with a minor amount of acid stabilizer, and then filtered to obtain the desired product.

In an aspect, the invention relates to the use of the composition or the mixture according to the invention as a protective and/or reinforcement material, particularly used in underground constructions.

The composition or the mixture is applied to a substrate selected from rock, concrete, wood, glass, resin, stone, earth, mud, sand and the like.

The composition or the mixture is applied to a substrate by conventional means in the art, such as brushing, casting, self-leveling, rolling, spraying, or injecting etc.

In one embodiment, Component I and Component II of the composition are stored in separate packages and are mixed on the spot for applications of the composition before applying to substrates.

The temperature for the use of the composition or the mixture is from −30° C. to 60° C. and preferably from −20° C. to 40° C. And the relative humidity for the use is from 1% to 99% and preferably from 5% to 95%.

The composition according to the invention may be applied in a conventional way in the art. In a preferred embodiment, the monomer (A) and the polymer (B) are mixed with the acidic stabilizer (C) and optional additives such as filler to give a ready-made formulation, and then adding an alkali accelerator such as triethylamine into the system and applying the mixture to the substrates. In a still preferred embodiment, the monomer (A) and the polymer (B) were firstly placed in a suitable vessel, and the acidic stabilizer (C) and optional additives such as filler was added into the vessel, thereby giving a ready-made Component I; subsequently, the alkali accelerator was placed in another suitable vessel as Component II, and then the Component I and Component II were adjacently placed and simultaneously sprayed out to the substrate. By this means, Component I and Component I are mixed in the air or mixed on the substrate when they are in contact with each other.

In the present invention, application of the composition or the mixture may be carried out in a way known to those skilled in the art, for example by brushing, casting, self-leveling, rolling, spraying, or injecting etc. It is noted that the specific way of application used in the present invention depends on the workability of the composition. Particularly, injecting requires a relatively longer gel time compared to spray coating.

In the embodiments of the present invention, the substrates or structures to be applied comprise a rock, concrete, wood, glass, resin layer, stone, earth, mud, and sand. In a preferred embodiment, the composition according to the invention is applied on top of a layer comprising the same composition.

In the embodiments of the present invention, the composition is used in underground construction as a protective and/or reinforcement material. As used herein, a protective material refers to materials applied to the surface of a structure to form a layer for the main purpose of protecting the surface. The term “protective” used herein may refer to a wide range of activities of protective nature, such as sealing, waterproofing or damp proofing, coating, painting, anti-corrosion, fireproofing, insulating, and antimicrobial etc. As used herein, a reinforcement material refers to materials applied to parts of an object or a structure for the main purpose of increasing the strength or stability of the structure. The term “reinforcement” used herein refers to a wide range of activities of reinforcing or consolidating nature, such as reinforcement, connecting various sections into one unit, filling voids or large spaces, sealing joints, bonding steel to masonry etc. In the embodiments of the present invention, the composition can be applied to the surface or to the body of a structure, or applied to both the surface or body thereof, depending on the purpose and property of the composition.

In the embodiments of the present invention, the composition can also be used in other civil engineering constructions which requires a fast curing time and strength build-up, a good balance of properties among tensile strength, flexibility, bonding strength, waterproofing, temperature and humidity tolerance.

In the embodiments of the present invention, the composition or the mixture is applied to wet substrates or structures.

In the embodiments of the present invention, the temperature for the use is from −30° C. to 60° C. and preferably from −20° C. to 40° C.

In the embodiments of the present invention, the relative humidity for the use is from 1% to 99% and preferably from 5% to 95%.

### Embodiment

The following embodiments are used to illustrate the invention in more details.

The 1^{st} embodiment is a composition comprising

(1) Component I comprising:
(A) at least one methylene malonate monomer having formula (I),

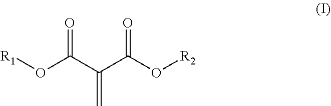

wherein R₁ and R₂ are in each case independently selected from the group consisting of C1-C15-alkyl, C2-C15-alkenyl and C3-C15-cyclolalkyl;
(B) at least one methylene malonate polymer having formula (II):

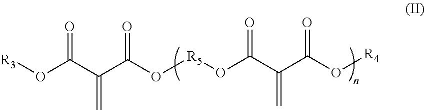

wherein, R₃ and R₄ are in each case independently selected from the group consisting of C1-C15-alkyl, C2-C15-alkenyl and C3-C15-cyclolalkyl;
n is an integer from 1 to 20; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from 2-ethylhexylamine, N-Octylamine, tridecylamine mixture of isomers, 3,3′-dimethyl-4,4′-diaminodicyclohexylmethane, 4,4′-diaminodicyclohexylmethane, isophorone diamine, neopentanediamine (2,2-Dimethylpropane-1,3-diamine), octamethylenediamine, polyetheramine D 2000, polyetheramine D 230, polyetheramine D 400, polyetheramine T 403, polyetheramine T 5000, 4,4′-diaminodiphenylmethane, benzylamine, dibutylethanolamine;
wherein, the monomer (A) is in an amount of 0-40 wt. %, the acidic stabilizer (C) is in an amount of 0.1-500 ppm, and the Component II is in an amount of 1 to 10 wt. %, in each case based on the total weight of the monomer (A) and the polymer (B).

The 2^{nd} embodiment is a composition comprising:

(1) Component I comprising:
(A) at least one methylene malonate monomer having formula (I),

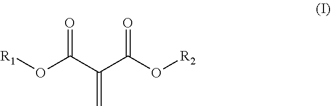

wherein R₁ and R₂ are in each case independently selected from the group consisting of C1-C15-alkyl, C2-C15-alkenyl and C3-C15-cyclolalkyl;
(B) at least one methylene malonate polymer having formula (II),

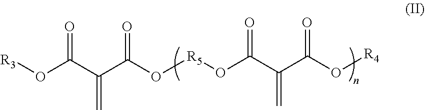

wherein R₃ and R₄ are in each case independently selected from the group consisting of C1-C15-alkyl, C2-C15-alkenyl and C3-C15-cyclolalkyl;
n is an integer from 1 to 15; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from di-(2-ethylhexyl)amine, dibutylamine, dicyclohexylamine, ditridecylamine mixture of isomers, 4,9-Dioxadodecane-1,12-diamine, di-(2-methoxyethyl)amine;
wherein, the monomer (A) is in an amount of 0-40 wt. %, the acidic stabilizer (C) is in an amount of 0.5-400 ppm, and the Component II is in an amount of 1 to 20 wt. %, in each case based on the total weight of the monomer (A) and the polymer (B).

The 3^{rd} embodiment is a composition comprising:

(1) Component I comprising:
(A) at least one methylene malonate monomer having formula (I),

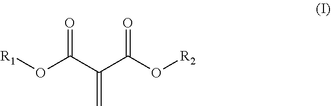

wherein R₁ and R₂ are in each case independently selected from the group consisting of C1-C15-alkyl, C2-C15-alkenyl and C3-C15-cyclolalkyl;
(B) at least one methylene malonate polymer having formula (II):

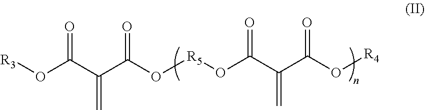

wherein, R₃ and R₄ are in each case independently selected from the group consisting of C1-C15-alkyl, C2-C15-alkenyl and C3-C15-cyclolalkyl;
n is an integer from 1 to 10; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from N,N-dimethylcyclohexylamine, tributylamine, tripropylamine, tris-(2-ethylhexyl)amine, triethylamine, 2-(diisopropylamino)ethylamine, tetramethyl-1,6-hexanediamine, pentamethyldietylenetriamine, bis(2-dimethylaminoethyl) ether, trimethylaminoethylethanolamine, tris(dimethylaminomethyl)phenol, 2-dimethylaminomethylphenol, dimethylethylamine, dimethylpropylamine, N,N-dimethylisopropylamine, N-Ethyldiisopropylamine, trimethylamine;
wherein, the monomer (A) is in an amount of 0-35 wt. %, and the acidic stabilizer (C) is in an amount of 1-300 ppm, and the Component II is in an amount of 0.03 to 5 wt. %, in each case based on the total weight of the monomer (A) and the polymer (B).

The 4^{th} embodiment is a composition comprising:

(1) Component I comprising:
(A) at least one methylene malonate monomer having formula (I),

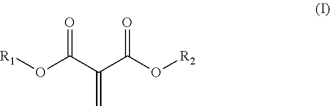

wherein R₁ and R₂ are in each case independently selected from the group of C6-C15-aryl;
(B) at least one methylene malonate polymer having formula (II),

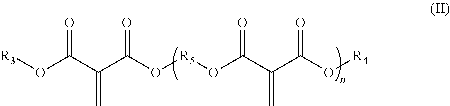

wherein R₃ and R₄ are in each case independently selected from the group of C1-C15-alkyl,
n is an integer from 1 to 8; and
R₅, if n=1 is, or if n>1 are in each case independently, selected from the group consisting of C1-C15-alkylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from 3-(cyclohexylamino)propylamine, diethylenetriamine, dipropylene triamine, N3-Amine 3-(2-Aminoethylamino)propylamine, N4-Amine N,N′-Bis-(3-Aminopropyl)ethylenediamine;
wherein, the monomer (A) is in an amount of 5-30 wt. %, and the acidic stabilizer (C) is in an amount of 5-250 ppm, and the Component II is in an amount of 0.5 to 5 wt. %, in each case based on the total weight of the monomer (A) and the polymer (B).

The 5^{th} embodiment is a composition comprising:

(1) Component I comprising:
(A) at least one methylene malonate monomer having formula (I),

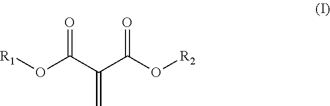

wherein R₁ and R₂ are in each case independently selected from the group of C1-C15-alkyl;
(B) at least one methylene malonate polymer having formula (II)m,

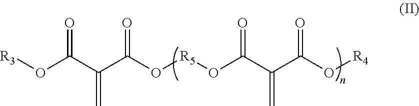

wherein R₃ and R₄ are in each case independently selected from the group of C1-C15-alkyl;
n is an integer from 1 to 6; and
R₅, if n=1 is, or if n>1 are in each case independently, selected from the group consisting of C1-C15-alkylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from N,N-Bis-(3-aminopropyl)methylamine, 3-(diethylamino)propylamine;
wherein, the monomer (A) is in an amount of 10-30 wt. %, the acidic stabilizer (C) is in an amount of 10-200 ppm, and the Component II is in an amount of 0.03 to 5 wt. %, in each case based on the total weight of the monomer (A) and the polymer (B).

The 6^{th} embodiment is a composition comprising:

(1) Component I comprising:
(A) at least one methylene malonate monomer having formula (I),

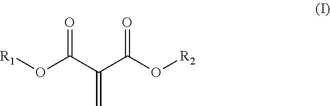

wherein R₁ and R₂ are in each case independently selected from the group consisting of C1-C15-alkyl, C2-C15-alkenyl and C3-C15-cyclolalkyl;
(B) at least one methylene malonate polymer having formula (II),

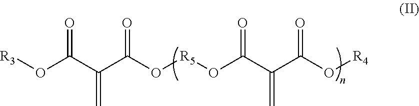

wherein R₃ and R₄ are in each case independently selected from the group consisting of C1-C15-alkyl, C2-C15-alkenyl and C3-C15-cyclolalkyl;
n is an integer from 1 to 8; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine; 3-dimethylaminopropane-1-ol, dimethylaminoethoxyethanol, diethanol-para-toluidine, diisopropanol-p-toluidine;
wherein, the monomer (A) is in an amount of 5-35 wt. %, the acidic stabilizer (C) is in an amount of 10-200 ppm, and the Component II is in an amount of 0.1 to 5 wt. %, in each case based on the total weight of the monomer (A) and the polymer (B).

The 7^{th} embodiment is a composition comprising:

(1) Component I comprising:
(A) at least one methylene malonate monomer having formula (I),

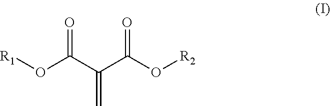

wherein R₁ and R₂ are in each case independently selected from the group consisting of C1-C15-alkyl, C2-C15-alkenyl and C3-C15-cyclolalkyl;
(B) at least one methylene malonate polymer having formula (II),

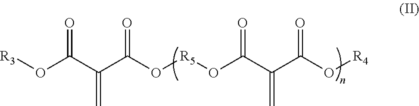

wherein, R₃ and R₄ are in each case independently selected from the group consisting of C1-C15-alkyl, C2-C15-alkenyl and C3-C15-cyclolalkyl;
n is an integer from 1 to 8; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene;
wherein, the monomer (A) is in an amount of 5-35 wt. %, the acidic stabilizer (C) is in an amount of 5-250 ppm, and the Component II is in an amount of 0.5 to 5 wt. %, in each case based on the total weight of the monomer (A) and the polymer (B).

The 8^{th} embodiment is a composition comprising:

(1) Component I comprising:
(A) at least one methylene malonate monomer having formula (I),

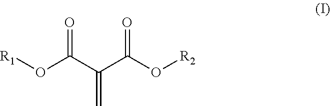

wherein R₁ and R₂ are in each case independently selected from the group consisting of C1-C15-alkyl, C2-C15-alkenyl and C3-C15-cyclolalkyl;
(B) at least one methylene malonate polymer having formula (II),

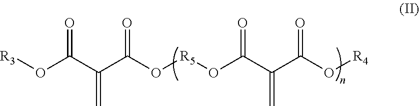

wherein R₃ and R₄ are in each case independently selected from the group consisting of C1-C15-alkyl, C2-C15-alkenyl and C3-C15-cyclolalkyl;
n is an integer from 1 to 10; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from metal or amine salts of polymer bound acids, 2,4-pentanedionate, diketones, monocarboxylic acids, polyacrylic acid co-polymers, benzoate salts, propionate salts, salts of amine or metal with halide, silicate, acetate or chloroacetate, metal hydroxide, metal oxide, said metal being selected from lithium, sodium, potassium, magnesium, calcium, copper, iron, zinc, aluminum, and cobalt etc.;
wherein, the monomer (A) is in an amount of 10-20 wt. %, the acidic stabilizer (C) is in an amount of 50-150 ppm, and the Component II is in an amount of 0.03 to 100 wt. %, in each case based on the total weight of the monomer (A) and the polymer (B).

The 9^{th} embodiment is a composition comprising:

(1) Component I comprising:
(A) at least one methylene malonate monomer having formula (I),

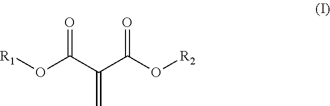

wherein, R₁ and R₂ are in each case independently selected from the group consisting of C1-C15-alkyl, C2-C15-alkenyl and C3-C15-cyclolalkyl;
(B) at least one methylene malonate polymer having formula (II),

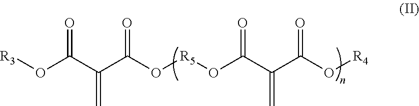

wherein R₃ and R₄ are in each case independently selected from the group consisting of C1-C15-alkyl, C2-C15-alkenyl and C3-C15-cyclolalkyl;
n is an integer from 1 to 12; and
R₅, if n=1 is, or if n>1 are in each case independently, selected from the group consisting of C1-C15-alkylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from sodium oxide, potassium oxide, calcium oxide, zinc oxide, copper oxide, magnesium oxide, aluminum oxide, ferric and ferrous oxide, sodium hydroxide, potassium hydroxide, zinc hydroxide, copper hydroxide, magnesium hydroxide, aluminum hydroxide, calcium hydroxide, ferric and ferrous hydroxide, sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, sodium silicate, potassium silicate, zinc silicate, copper silicate, magnesium silicate, iron silicate and aluminum silicate;
wherein, the monomer (A) is in an amount of 0-40 wt. %, the acidic stabilizer (C) is in an amount of 50-100 ppm, and the Component II is in an amount of 35-100 wt. %, in each case based on the total weight of the monomer (A) and the polymer (B).

The 10^{th} embodiment is a composition comprising:

(1) Component I comprising:
(A) at least one methylene malonate monomer having formula (I),

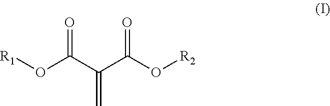

wherein R₁ and R₂ are in each case independently selected from the group consisting of e C1-C15-alkyl, C2-C15-alkenyl, C3-C15-cycloalkyl, C6-C15-aryl, halo-C1-C15-alkyl;
(B) at least one methylene malonate polymer having formula (II),

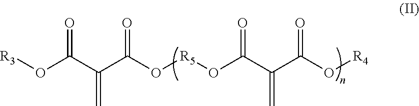

wherein R₃ and R₄ are in each case independently selected from the group consisting of C1-C15-alkyl, C2-C15-alkenyl, C3-C15-cycloalkyl, C6-C15-aryl, halo-C1-C15-alkyl;
n is an integer from 1 to 15; and
R₅, if n=1 is, or if n>1 are in each case independently, selected from the group of C1-C15-alkylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from piperidene, piperazine, pyridine morpholine, preferably from N-Methylmorpholine, 4-(2-hydroxyethyl)morpholine, 2,2′-Dimorpholinodiethylether etc.;
wherein, the monomer (A) is in an amount of 10-40 wt. %, the acidic stabilizer (C) is in an amount of 50-100 ppm, and the Component II is in an amount of 0.5-30 wt. %, in each case based on the total weight of the monomer (A) and the polymer (B).

The 11^{th} embodiment is a composition comprising:

(1) Component I comprising:
(A) at least one methylene malonate monomer having formula (I),

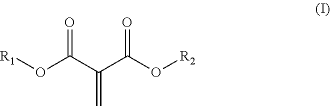

wherein R₁ and R₂ are in each case independently selected from the group consisting of C1-C15-alkyl, C2-C15-alkenyl, C3-C15-cycloalkyl, C6-C15-aryl, halo-C1-C15-alkyl;
(B) at least one methylene malonate polymer having formula (II),

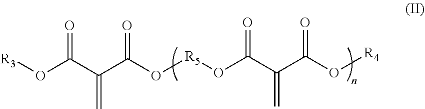

wherein R₃ and R₄ are in each case independently selected from the group consisting of C1-C15-alkyl, C2-C15-alkenyl, C3-C15-cycloalkyl, C6-C15-aryl, halo-C1-C15-alkyl;
n is an integer from 1 to 20; and
R₅, if n=1 is, or if n>1 are in each case independently, selected from the group of C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from lithium chloride, tris(dimethylaminomethyl)phenol, 2-dimethylaminomethylphenol, diethylenetriamine, N,N,N′,N′-Tetrakis(2-hydroxyethyl)ethylenediamine;
wherein, the monomer (A) is in an amount of 10-40 wt. %, the acidic stabilizer (C) is in an amount of 10-100 ppm, and the Component II is in an amount of 0.03-1 wt. %, in each case based on the total weight of the monomer (A) and the polymer (B).

The 12^{th} embodiment is a composition comprising:

(1) Component I comprising:
(A) at least one methylene malonate monomer having formula (I),

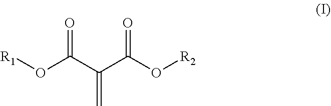

wherein, R₁ and R₂ are in each case independently selected from the group of C1-C15-alkyl;
(B) at least one methylene malonate polymer having formula (II),

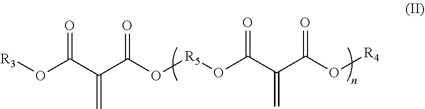

wherein, R₃ and R₄ are in each case independently selected from the group of C1-C15-alkyl;
n is an integer from 1 to 8; and
R₅, if n=1 is, or if n>1 are in each case independently, selected from the group of C6-C15-arylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from sodium propionate, sodium benzoate, 2,2′-Dimorpholinodiethylether;
wherein, the monomer (A) is in an amount of 10-40 wt. %, the acidic stabilizer (C) is in an amount of 10-100 ppm, and the Component II is in an amount of 1-35 wt. %, in each case based on the total weight of the monomer (A) and the polymer (B).

The 13^{th} embodiment is a composition comprising:

(1) Component I comprising:
(A) at least one methylene malonate monomer having formula (I),

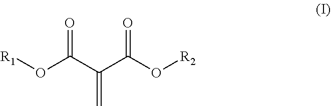

wherein R₁ and R₂ are in each case independently selected from the group of C1-C15-alkyl;
(B) at least one methylene malonate polymer having formula (II),

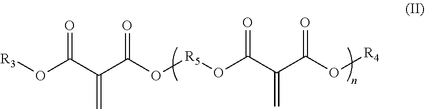

wherein, R₃ and R₄ are in each case independently selected from the group of C1-C15-alkyl;
n is an integer from 1 to 8; and
R₅, if n=1 is, or if n>1 are in each case independently, selected from the group of C6-C15-arylene and C6-C15-arylene; and
(C) at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, and dichloroacetic acid;
and
(2) Component II comprising at least one selected from calcium hydroxide, magnesium oxide, Manganese acetylacetonate, tetrabutyl ammonium chloride, tetrabutyl ammonium hydroxide;
wherein, the monomer (A) is in an amount of 10-40 wt. %, the acidic stabilizer (C) is in an amount of 10-100 ppm, and the Component II is in an amount of 35-100 wt. %, in each case based on the total weight of the monomer (A) and the polymer (B).

The 14^{th} embodiment is a mixture comprising the composition according to any one of embodiments 1-13 which further comprises one or more additives selected from the group consisting of plasticizers, thixotropic agents, adhesion promoters, antioxidants, light stabilizers, UV stabilizer, filler, cement, lime stone, surfactant, wetting agents, viscosity modifier, dispersants, air release agents, anti-sagging agents, anti-setting agents, defoaming agent, coloring agent, fiber, polymer powder, mesh, chip, hollow spheres and inert resins.

The 15^{th} embodiment is a mixture comprising the composition according to any one of embodiments 1-14, which further comprises one or more additives selected from the group consisting of plasticizers, anti-sagging agents, thixotropic agents, surfactant, filler, lime stone, polymer powder and defoaming agent.

The 16^{th} embodiment is a mixture comprising the composition according to any one of embodiments 1-14, which further comprises one or more additives selected from the group consisting of anti-setting agents, antioxidants, and fillers.

The 17^{th} embodiment is a mixture comprising the composition according to any one of embodiments 1-14, which further comprises one or more additives selected from the group consisting of viscosity modifier, adhesion promoters, pigments, air release agents, inert resin and defoaming agent.

The 18^{th} embodiment is a mixture comprising the composition according to any one of embodiments 1-14, which further comprises other additives selected from the group consisting of pigments, dispersants, thixotropic agents, air release agents, fiber and fillers.

The 19^{th} embodiment is a mixture comprising the composition according to any one of embodiments 1-14, which further comprises other additives selected from the group consisting of antioxidants, anti-sagging agents, air release agents, defoaming agent, chip and fillers.

### Example

The present invention will now be described with reference to Examples and Comparative Examples, which are not intended to limit the scope of the present invention.

The following starting materials were used:

Diethyl malonate (DEM), dihexyl malonate (DHM) and dicyclohexyl malonate (DCM) were purchased from Alfa Aesar. Paraformaldehyde, potassium acetate, copper (II) acetate, Novazym 435 as catalyst were purchased from Acros Organics. Maleic acid, methane sulfonic acid, 1,5-pentanediol, 2-methylpropane-1,3-diol, 1,4-phenylenedimethanol were purchased from Alfa Aesar. Sodium benzoate, lithium chloride, calcium hydroxide, sulfuric acid were purchased from Sigma-Aldrich. 2-(dimethylaminomethyl)phenol was purchased from Tokyo Chemical Industry. Trifluoromethanesulfonic acid was purchased from Aladdin.

### Analytical Methods

### (1) NMR (Nuclear Magnetic Resonance)

Routine one-dimensional NMR spectroscopy was performed on either a 400 MHz Varian® spectrometer or a 400 MHz Bruker® spectrometer. The samples were dissolved in deuterated solvents. Chemical shifts were recorded on the ppm scale and were referenced to the appropriate solvent signals, such as 2.49 ppm for DMSO-d6, 1.93 ppm for CD₃CN, 3.30 ppm for CD₃OD, 5.32 ppm for CD₂Cl₂ and 7.26 ppm for CDCl₃ for 1H spectra.

### (2) GC-MS (Gas Chromatography Mass Spectrometry)

GC-MS was obtained with a Hewlett Packard 5970 mass spectrometer equipped with Hewlett Packard 5890 Gas Chromatograph. The ion source was maintained at 270° C.

### (3) ESI-MS (Electrospray Ionization Mass Spectrometry)

Electrospray ionization mass spectra were obtained using a Thermo LTQ-FT, a hybrid instrument consisting of a linear ion trap mass analyzer and a Fourier transform ion cyclotron resonance (FT-ICR) mass analyzer.

### Measurement Methods

### (1) Gel Time

Gel time means the time from the start of mixing Component I and Component II of the composition to the composition becoming too viscous and losing the workability. Particularly, short gel time (for example 0.5-5 min) is suitable for spray coating, whereas longer gel time (for example 15-30 min) is needed for roller coating. Gel time is measured according to DIN EN ISO 9514.

### (2) Dry Through Time

Dry through Time means the time from the start of mixing Component I and Component II of the composition and forming the composition into a layer with certain thickness to said layer becoming completely dry. Dry through time is measured according to ASTM D1640.

### (3) Hardness

Hardness (Shored D) is determined according to DIN53505.

### (4) Adhesive Bonding

Adhesive bonding is measured according to ASTM D7234-12.

(5) Elongation and Tensile Strength Elongation and Tensile Strength are each determined according to DIN 53504.

### Preparation Example

### I. The Preparation of Monomer (A)

### Example 1: The Preparation of Diethyl Methylenemalonate (DEMM)

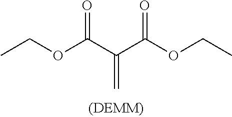

<1>. In a two-liter 3-neck round bottom flask (equipped with a condenser), 60 g of paraformaldehyde (2 mol), 10 g of potassium acetate and 10 g of copper (II) acetate were mixed in 80 ml of tetrahydrofuran (THF).

<2>. This mixture was stirred and heated at 65° C. for 40 min. From an additional funnel, 160 g (1 mol) of diethyl malonate (DEM) was then added dropwise to the reaction mixture.

<3>. At the end of the addition of DEM (about an hour), the reaction mixture was further stirred at 65° C. for 2 hours.

<4>. The reaction mixture was then cooled to room temperature and 10 g of sulfuric acid was added into the flask with stirring.

<5>. The precipitates were then removed by filtration and the filtrate was collected. 0.01 g of sulfuric acid (60 ppm) was added to the collected filtrate.

<6>. The filtrate was then distilled at reduced pressure. Diethyl Methylenemalonate was collected at 55-70° C. with about 1.5 mm Hg of vacuum as the crude monomer.

<7>. The crude monomer (with 60 ppm of sulfuric acid) was further fractionally distilled with stainless steel packed column under reduced vacuum. This gives 141 g (yield of 82%, purity of 98%) pure monomer.

<8>. The monomer was stabilized with 40 ppm of sulfuric acid.

1H-NMR (400 MHz, CDCl₃) δ 6.45 (s, 2H), 4.22 (q, 4H), 1.24 (t, 6H).

GC-MS (m/z): 173, 145, 127, 99, 55.

The ion at m/z 173 represents the protonated DEMM.

### Example 2: The Preparation of Dihexyl Methylene Malonate (DHMM)

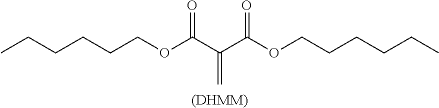

The preparation is carried out according to Example 1, except for using dihexyl malonate in step 2. This gives 227 g (yield of 80%, purity of 95%) pure monomer. The monomer was stabilized with 60 ppm of sulfuric acid.

GC-MS (m/z): 285.

### Example 3: The Preparation of Dicyclohexyl Methylene Malonate (DCHMM)

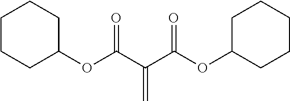 [SMILES: C=C(C(=O)OC1CCCCC1)C(=O)OC1CCCCC1]

The preparation is carried out according to Example 1, except for using dicyclohexyl malonate in step 2. This gives 224 g (yield of 80%, purity of 95%) pure monomer. The monomer was stabilized with 60 ppm of sulfuric acid.

GC-MS (m/z): 281.

### II. The Preparation of Polymer (B)

### Example 4: The Preparation of Polymer (B-1)

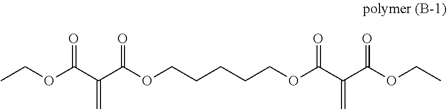 [SMILES: C=C(C(=O)OCC)C(=O)OCCCCCOC(=O)C(=C)C(=O)OCC]

In a round flask (equipped with a condenser), 0.5 g Novazym 435 (catalyst), 17.3 g DEMM (0.1 mol) and 4.2 g 1,5-pentanediol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 357.

### Example 5: The Preparation of Polymer (B-2)

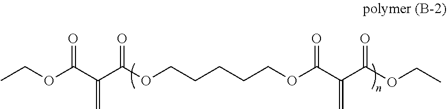

In a round flask (equipped with a condenser), 0.5 g Novazym 435 (catalyst), 17.3 g DEMM (0.1 mol) and 8.3 g 1,5-pentanediol (0.08 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product, wherein n is an integer from 2 to 8.

ESI-MS (m/z): 541 (n=2), 725 (n=3), 909 (n=4), 1093 (n=5), 1277 (n=6), 1461 (n=7), 1645 (n=8).

### Example 6: The Preparation of Polymer (B-3)

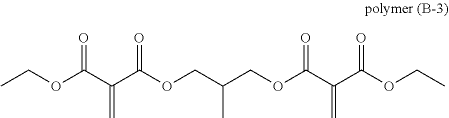 [SMILES: C=C(C(=O)OCC)C(=O)OCC(C)COC(=O)C(=C)C(=O)OCC]

In a round flask (equipped with a condenser), 0.5 g Novazym 435 (catalyst), 17.3 g DEMM (0.1 mol) and 3.6 g 2-methylpropane-1,3-diol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 343

### Example 7: The Preparation of Polymer (B-4)

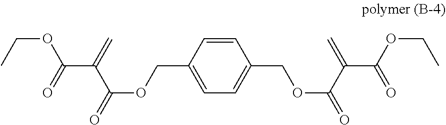 [SMILES: C=C(C(=O)OCC)C(=O)OCc1ccc(COC(=O)C(=C)C(=O)OCC)cc1]

In a round flask (equipped with a condenser), 0.5 g Novazym 435 (catalyst), 17.3 g DEMM (0.1 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product.

ESI-MS (m/z): 391

### Example 8: The Preparation of Polymer (B-5)

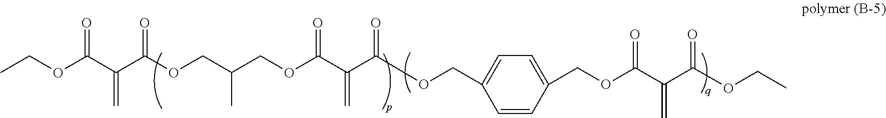

In a round flask (equipped with a condenser), 0.5 g Novazym 435 (catalyst), 17.3 g DEMM (0.1 mol) 3.6 g 2-methylpropane-1,3-diol (0.04 mol) and 5.52 g 1,4-phenylenedimethanol (0.04 mol) were added. The mixture was stirred and heated at 65° C. for 6 hours, while the alcohol generated was removed through evaporation. The reaction mixture was then cooled to room temperature and stabilized with 10 ppm maleic acid. The reaction mixture was filtered to remove the catalyst. This gives the desired product, wherein the sum of p and q is an integer from 2 to 8.

ESI-MS (m/z): 561 (p=1, q=1), 779 (p=1, q=2), 731 (p=2, q=1), 949 (p=2, q=2), 997 (p=1, q=3), 901 (p=3, q=1), 1215 (p=1, q=4), 1167 (p=2, q=3), 1119 (p=3, q=2), 1071 (p=4, q=1), 1433 (p=1, q=5), 1385 (p=2, q=4), 1337 (p=3, q=3), 1289 (p=4, q=2), 1241 (p=5, q=1)

### III. The Preparation and Performance of the Compositions

### Example 9: Composition Comprising Component II Comprising Sodium Benzoate

According to the following general procedure, the compositions as per Table 1 were prepared and later applied on a concrete board by using gauge Mayer rod in each case.

In the respective blending proportions shown in Table 1, the monomer (A) and the polymer (B) were first placed in a plastic vessel with a magnetic stir bar at 25° C. and under atmospheric pressure. While stirring, without heating, at 900 rpm, the acidic stabilizer (C) was added into the vessel. The mixture is continuously stirred for an additional 5 minutes. This gives a ready-made Component I.

Then, Component II was added to Component I and stirred to form the composition.

TABLE 1
The components of the compositions in Example 9

| Composition | Inventive composition | | | | | | | | | | | |
|---|---|---|---|---|---|---|---|---|---|---|---|---|
| Example | 9A | 9B | 9C | 9D | 9E | 9F | 9G | 9H | 9I | 9J | 9K | 9L |

| | | | | | |
|---|---|---|---|---|---|
| Component | (A): | DCHMM | 0 | 20 | 40 |
| I | Monomer | | | | |
| | (wt. %) | | | | |
| | (B): | Polymer | 44 | 35 | 26 |
| | Polymer | (B-1) | | | |
| | (wt. %) | Polymer | 56 | 45 | 34 |
| | | (B-2) | | | |
| | (C): | (C)-1 | 30 | 28 | 25 |
| | Acidic | MSA | | | |
| | Stabilizer | (C)-2 | 10 | 11 | 11 |
| | (ppm) | H₂SO₄ | | | |
| | | (C)-3 | 3 | 3 | 3 |
| | | TFA | | | |

| | | | | | | | | | | | | | |
|---|---|---|---|---|---|---|---|---|---|---|---|---|---|
| Component | Sodium Benzoate | 1 | 5 | 10 | 20 | 1 | 5 | 10 | 20 | 1 | 5 | 10 | 20 |
| II | (wt. %)* | | | | | | | | | | | | |

*based on the total weight of monomer (A) and polymer (B)

### Example 10

Gel time of the compositions obtained according to Example 9 were tested. The results are shown in the following Table 2.

The composition was applied onto the surface of the concrete board, and then a 2.5 gauge Mayer rod was used to drag the composition down on the concrete board resulting in a film with 0.2 mm thickness for adhesive bonding test. The dry through time of said film obtained according to compositions in Example 9 were tested. The results are also shown in the following Table 2.

TABLE 2
Gel time and dry through time of the compositions in Example 9

| Example | 9A | 9B | 9C | 9D | 9E | 9F | 9G | 9H | 9I | 9J | 9K | 9L |
|---|---|---|---|---|---|---|---|---|---|---|---|---|
| Gel time | 16.5 | 6.5 | 4.5 | 3.3 | 12.0 | 6.0 | 5.3 | 3.7 | 13 | 6.5 | 5.5 | 4.5 |
| (min) | | | | | | | | | | | | |
| Dry | 26 | 15.5 | 9.5 | 4.5 | 21.5 | 11.5 | 8 | 5 | 16 | 13 | 9 | 6.7 |
| through | | | | | | | | | | | | |
| Time | | | | | | | | | | | | |
| (min) | | | | | | | | | | | | |

It is advantageous that the protective and/or reinforcement material used in underground constructions has a gel time of less than 30 min and a dry through time of less than 8 h. Particularly, a composition with a relatively long gel time, eg. between 15-30 min, can be applied by brushing or rolling. A composition with a short gel time, eg. between 0.5-5 min, can be applied by spraying, when the Component I and Component I are stored in separate containers and mixed when they are both sprayed out. From the above, it shows that the compositions of Example 9 exhibit fast and controlled curing, thus are suitable for use in underground constructions.

### Example 11

Mechanical properties and adhesive bonding of the compositions obtained according to Example 9 were tested after 7 days and the results are shown in Table 3 below.

TABLE 3
Mechanical properties and adhesive
bonding of the compositions in Example
9

| | Elongation | Tensile | Adhesive |
|---|---|---|---|
| | Rate | Strength | Bonding |
| Example | (%) | (MPa) | (N/mm²) |
| 9A | 3.2 | 10.6 | >3.2 |
| 9B | 1.4 | 8.5 | >3.0 |
| 9C | 2.0 | 14.8 | >2.8 |
| 9D | 1.5 | 13.0 | >2.9 |
| 9E | 1.7 | 7.2 | >3.5 |
| 9F | 1.2 | 7.3 | >3.1 |
| 9G | 1.6 | 10.0 | >3.0 |
| 9H | 1.4 | 13.8 | >3.2 |
| 9I | 2.1 | 9.9 | >3.4 |
| 9J | 1.9 | 12.1 | >3.0 |
| 9K | 1.4 | 8.5 | >3.1 |
| 9L | 3.5 | 9.4 | >3.0 |

It is advantageous that the inventive compositions have a good elongation rate of no less than 1% and a good tensile strength of no less than 7 Mpa, showing excellent flexibility and mechanical properties, and a good adhesive bonding of no less than 2 N/mm². The above results indicate that the compositions of the invention have excellent mechanical properties and bonding strength, thus are suitable for use in underground constructions.

### Example 12

Hardness of the compositions obtained according to Example 9 were tested and the results are shown in Table 4 below.

TABLE 4
Hardness (shore D) of the compositions in Example 9

| | Example | | | | | | | | | | | |
|---|---|---|---|---|---|---|---|---|---|---|---|---|
| Time | 9A | 9B | 9C | 9D | 9E | 9F | 9G | 9H | 9I | 9J | 9K | 9L |
| 20 min | 60 | 66 | 64 | 74 | 8.4 | 64 | 66 | 75 | 25 | 70 | 76 | 70 |
| 5 h | 65 | 68 | 68 | 76 | 70 | 65 | 67 | 75 | 70 | 77 | 78 | 76 |
| 24 h | 70 | 74 | 70 | 76 | 74 | 70 | 70 | 78 | 70 | 78 | 78 | 80 |

It is advantageous that the compositions of the invention can achieve good hardness after sufficient curing, i.e. the shore D hardness of the compositions after 24 hours is no less than 70. Moreover, the compositions can also cure at a fast speed, i.e. the composition has satisfactory early harness after several hours of curing. The above results indicate that starting from mixing Component I and Component II, the composition's Shore D hardness after 5 hours is no less than 90% of its Shore D hardness after 24 hours. Such curing profile makes the compositions suitable for use in underground constructions.

### Example 13: Compositions Comprising Component II Comprising LiCl

According to the procedure in Example 9, the compositions as per Table 5 were prepared.

TABLE 5
The components of the compositions in Example 13

| Composition | | | Invention Composition | | | |
|---|---|---|---|---|---|---|
| Example | | | 13A | 13B | 13C | 13D |
| Component | (A): | DCHMM | 0 | 0 | 40 | 40 |
| I | Monomer | | | | | |
| | (wt. %) | | | | | |
| | (B): | Polymer | 44 | 44 | 26 | 26 |
| | Polymer | (B-1) | | | | |
| | (wt. %) | Polymer | 56 | 56 | 34 | 34 |
| | | (B-2) | | | | |
| | (C): Acidic | (C)-1 | 30 | 30 | 25 | 25 |
| | Stabilizer | MSA | | | | |
| | (ppm) | (C)-2 | 10 | 10 | 11 | 11 |
| | | H₂SO₄ | | | | |
| | | (C)-3 TFA | 3 | 3 | 3 | 3 |

| | | | | | |
|---|---|---|---|---|---|
| Component | Lithium chloride | 0.035 | 0.05 | 0.035 | 0.05 |
| II | (wt. %)* | | | | |

*based on the total weight of monomer (A) and polymer (B)

### Example 14

Similar to Example 10, gel time and dry through time of Example 13 were tested. The results are shown in the following Table 6.

TABLE 6
Gel time and dry through time of
the compositions in Example 13

| Example | 13A | 13B | 13C | 13D |
|---|---|---|---|---|
| Gel time (minutes) | 8.5 | 5.5 | 11 | 7 |
| Dry through Time | 2.5 | 2 | 3 | 2 |
| (hours) | | | | |

It is advantageous that the protective and/or reinforcement material used in underground constructions has a gel time of less than 30 min and a dry through time of less than 8 h. A composition with a short gel time, eg. between 0.5-5 min, can be applied to the substrate by spraying, when the Component I and Component I are stored in separate containers and mixed when they are both sprayed out. From the above, it shows that the inventive compositions exhibit fast and controlled curing, thus are suitable for use in underground constructions.

### Example 15

Mechanical properties and adhesive bonding of the compositions obtained according to Example 13 were tested after 7 days and the results are shown in Table 7 below.

TABLE 7
Mechanical properties and adhesive
bonding of the compositions in Example
13

| Example | 13A | 13B | 13C | 13D |
|---|---|---|---|---|
| Elongation Rate (%) | 5.9 | 4.9 | 3.7 | 1.0 |
| Tensile Strength (MPa) | 10.7 | 12.6 | 12.8 | 8.8 |
| Adhesive Bonding | >3.1 | >2.8 | >2.9 | >2.8 |
| (N/mm²) | | | | |

It is advantageous that the inventive composition has a good elongation rate of no less than 1% and a good tensile strength of no less than 7 Mpa, showing excellent flexibility and mechanical properties, and a good adhesive bonding of no less than 2 N/mm². The above results indicate that the compositions of the invention have excellent mechanical properties and bonding strength, thus are suitable for use in underground construction.

### Example 16

Hardness of the compositions obtained according to Example 13 were tested and the results are shown in Table 8 below.

TABLE 8
Hardness (shore D) of the
compositions in Example 13

| | Example | | | |
|---|---|---|---|---|
| Time | 13A | 13B | 13C | 13D |
| 20 min | 44 | 70 | 51 | 60 |
| 3 h | 61 | 77 | 60 | 68 |
| 24 h | 71 | 76 | 74 | 71 |

It is advantageous that the compositions of the invention can achieve good hardness after sufficient curing, i.e. starting from mixing Component I and Component II, the shore D hardness of the compositions after 24 hours is no less than 70. Moreover, the compositions can also cure at a fast speed, i.e. the composition has satisfactory early harness after several hours of curing. The above results indicate that starting from mixing Component I and Component II, the composition's Shore D hardness after 3 hours is no less than 80% of its Shore D hardness after 24 hours. Such curing profile makes the compositions suitable for use in underground constructions.

### Example 17: Composition Comprising Component II Comprising Ca(OH)₂

According to the procedure in Example 9, the compositions as per Table 9 were prepared.

TABLE 9
The components of the compositions in Example 17

| Composition | | | Invention Composition | | | | |
|---|---|---|---|---|---|---|---|
| Example | | | 17A | 17B | 17C | 17D | 17E |
| Component | (A): | DCHMM | 0 | 0 | 0 | 0 | 40 |
| I | Monomer | | | | | | |
| | (wt. %) | | | | | | |
| | (B): | Polymer | 44 | 44 | 44 | 44 | 26 |
| | Polymer | (B-1) | | | | | |
| | (wt. %) | Polymer | 56 | 56 | 56 | 56 | 34 |
| | | (B-2) | | | | | |
| | (C): | (C)-1 | 30 | 30 | 30 | 30 | 25 |
| | Acidic | MSA | | | | | |
| | Stabilizer | (C)-2 | 10 | 10 | 10 | 10 | 11 |
| | (ppm) | H₂SO₄ | | | | | |
| | | (C)-3 | 3 | 3 | 3 | 3 | 3 |
| | | TFA | | | | | |

| | | | | | | |
|---|---|---|---|---|---|---|
| Component | Ca(OH)₂ (wt. %)* | 40 | 50 | 80 | 100 | 80 |
| II | | | | | | |

*based on the total weight of monomer (A) and polymer (B)

### Example 18

Similar to Example 10, gel time of Example 17 were tested. The results are shown in the following Table 10.

TABLE 10
Gel time of the
compositions in Example 17

| Example | 17A | 17B | 17C | 17D | 17E |
|---|---|---|---|---|---|
| Gel time | 7.5 | 7 | 3 | 2 | 3 |
| (minutes) | | | | | |

It is advantageous that the protective and/or reinforcement material used in underground constructions has a gel time of less than 30 min and a dry through time of less than 8 h. A composition with a short gel time, eg. between 0.5-5 min, can be applied to the substrate by spraying, when the Component I and Component I are stored in separate containers and mixed when they are both sprayed out. From the above, it shows that the inventive compositions exhibit fast and controlled curing, thus are suitable for use in underground constructions.

### Example 19

Mechanical properties and adhesive bonding of the compositions obtained according to Example 17 were tested after 7 days and the results are shown in Table 11 below.

TABLE 11
Mechanical properties and adhesive
bonding of the compositions in
Example 17

| Example | 17B | 17C |
|---|---|---|
| Elongation Rate (%) | 1.0 | 2.7 |
| Tensile Strength (MPa) | 9.6 | 10.2 |
| Adhesive Bonding (N/mm²) | >2.9 | >2.3 |

It is advantageous that the inventive composition has a good elongation rate of no less than 1% and a good tensile strength of no less than 7 Mpa, showing excellent flexibility and mechanical properties, and a good adhesive bonding of no less than 2 N/mm². The above results indicate that the compositions of the invention have excellent mechanical properties and bonding strength, thus are suitable for use in underground construction.

### Example 20

Hardness of the compositions obtained according to Example 17 were tested and the results are shown in Table 12 below.

TABLE 12
Hardness (Shore D) of the
compositions in Example 18

| | Example | | | | |
|---|---|---|---|---|---|
| Time | 17A | 17B | 17C | 17D | 17E |
| 20 min | 4.2 | 6.7 | 30 | 28 | 24 |
| 2 h | 53 | 58 | 60 | 72 | 50 |
| 24 h | 70 | 74 | 72 | 74 | 70 |

It is advantageous that the compositions of the invention can achieve good hardness after sufficient curing, i.e. starting from mixing Component I and Component II, the shore D hardness of the compositions after 24 hours is no less than 70. Moreover, the compositions can also cure at a fast speed, i.e. the composition has satisfactory early harness after several hours of curing. The above results indicate that starting from mixing Component I and Component II, the composition's Shore D hardness after 2 hours is no less than 70% of its Shore D hardness after 24 hours. Such curing profile makes the compositions suitable for use in underground constructions.

The results of sodium benzoate, LiCl and Ca(OH)₂ as alkali accelerators also show that the composition is versatile and accommodating to various alkali compounds. The curing process of the composition can be promoted at different degrees depending on the nature and dosage of the alkali compounds. Therefore, the composition according to the invention can meet a wide range of requirements on the cost, application mode, and usage of the protective and/or reinforcement material.

### Comparative Example

### Compositions of Comparative Example 1-3

According to the procedure in Example 9, the compositions as per Table 13 were prepared.

TABLE 13
The components of the compositions
in Comparative Example 1-3

| Comparative Example | | | 1 | 2 | 3 |
|---|---|---|---|---|---|
| Component I | (A): Monomer | DCHMM | — | — | 40 |
| | (wt. %) | DEMM | 5 | 2 | |
| | | DHMM | 50 | 80 | — |
| | (B): Polymer | Polymer (B-1) | 20 | 8 | 27 |
| | (wt. %) | Polymer (B-2) | 25 | 10 | 33 |
| | (C): Acidic | (C)-1 MSA | 30.5 | 29.5 | 25 |
| | Stabilizer | (C)-2 H₂SO₄ | 5.5 | 9 | 11 |
| | (ppm) | (C)-3 TEA | 9.5 | 8.5 | — |

| | | | | |
|---|---|---|---|---|
| Component II | DMP10 (wt. %) | 0.5 | 0.5 | — |
| | Calcium hydroxide (wt. %) | — | — | 30 |

Similar to Example 10, gel time and dry through time of Comparative Example 1-3 were tested. The results are shown in the following Table 14.

TABLE 14
Gel time and dry through time of the
compositions in Comparative Example
1-3

| Comparative Example | 1 | 2 | 3 |
|---|---|---|---|
| Gel time (minutes) | 32 | 20 | 12 |
| Dry through Time (minutes) | 39 | 45 | 25 |
| Elongation Rate (%) | 13 | N.A.* | 5.106 |
| Tensile Strength (MPa) | 3 | N.A.* | 3.473 |

*The sample was easily broken under touch and cannot be made into a standard bar for testing, and thus cannot be measured.

From the above, it shows that compositions of Comparative 1, 2 and 3 have a short gel time whereas their tensile strength is too weak to be used in underground constructions.

Hardness of the composition obtained according to Comparative Example 3 was tested and the results are shown in Table 15 below.

TABLE 15
Hardness (Shore D) of the
compositions in
Comparative Example 3

| | Example |
|---|---|
| Time | Comparative Example 3 |
| 2 h | 17 |
| 24 h | 46 |

It is advantageous that the compositions of the invention can achieve good hardness after sufficient curing, i.e. starting from mixing Component I and Component II, the shore D hardness of the compositions after 24 hours is no less than 70. Moreover, the compositions can also cure at a fast speed, i.e. the composition has satisfactory early harness after several hours of curing. The above results indicate that starting from mixing Component I and Component II, the composition's Shore D hardness after 2 hours is no less than 70% of its Shore D hardness after 24 hours. Such curing profile makes the compositions suitable for use in underground constructions.

It shows that the composition of Comparative Example 3 cures at a much slower speed than Inventive Examples. Starting from mixing Component I and Component II, its shore D hardness after 24 hours is not sufficiently high, and the Shore D hardness after 2 hours is less than 40% of its Shore D hardness after 24 hours.

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions, and methods, and such variations are regarded as within the ambit of the invention. Thus, it is intended that the present invention cover such modifications and variations as come within the scope of the appended claims and their equivalents.

1.-28. (canceled)

29. A two-component composition comprising:
(1) Component I comprising:
(A) at least one methylene malonate monomer having formula (I), 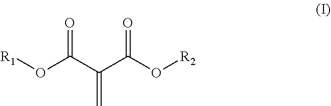
wherein, R₁ and R₂ are in each case independently selected from the group consisting of C1-C15-alkyl, C2-C15-alkenyl, C3-C15-cyclolalkyl, C2-C15-heterocyclyl, C2-C15-heterocyclyl-(C1-C15-alkyl), C6-C15-aryl, C6-C15-aryl-C1-C15-alkyl, C2-C15-heteroaryl, C2-C15-heteroaryl-C1-C15-alkyl, C1-C15-alkoxy-C1-C15-alkyl, halo-C1-C15-alkyl, halo-C2-C15-alkenyl, and halo-C3-C15-cyclolalkyl, each of which radicals is optionally substituted, the heteroatom being selected from N, O and S;
(B) at least one methylene malonate polymer having formula (II), 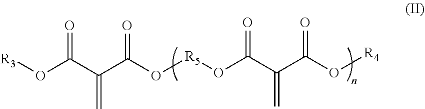
wherein, R₃ and R₄ are, in each case independently selected from the group consisting of C1-C15-alkyl, C2-C15-alkenyl, C3-C15-cyclolalkyl, C2-C15-heterocyclyl, C2-C15-heterocyclyl-C1-C15-alkyl, C6-C15-aryl, C6-C15-aryl-(C1-C15-alkyl), C2-C15-heteroaryl, C2-C15-heteroaryl-C1-C15-alkyl, C1-C15-alkoxy-C1-C15-alkyl, halo-C1-C15-alkyl, halo-C2-C15-alkenyl, and halo-C3-C15-cyclolalkyl, each of which radicals is optionally substituted, the heteroatom being selected from N, O and S,
n is an integer from 1 to 20,
R₅, if n=1 is, or if n>1 are in each case independently, selected from the group consisting of C1-C15-alkylene, C2-C15-alkenylene, C2-C15-alkynylene, C6-C15-arylene, C3-C15-cyclolalkylene, C3-C15-cyclolalkenylene, C3-C15-cyclolalkynylene, C2-C15-heterocyclylene, and C2-C15-heteroarylene, each of which radicals is optionally substituted, the heteroatom being selected from N, O and S, wherein R₅ is optionally interrupted by a radical selected from N, O and S; and
(C) at least one acidic stabilizer; and
(2) Component II comprising:
at least one alkali accelerator;
wherein, the monomer (A) is in an amount of from 0 to 40 wt. %, preferably from 0 to 30 wt. % and more preferably from 0 to 20 wt. %, and most preferably 0 to 10 wt. %, in each case based on the total weight of the monomer (A) and the polymer (B);
the acidic stabilizer (C) is in an amount of from 0.1 to 500 ppm, preferably from 0.1 to 300 ppm and more preferably from 0.1 to 200 ppm, and most preferably from 0.1 to 100 ppm;
and
the Component II is in an amount of from 0.03 to 100 wt. % based on the total weight of the monomer (A) and the polymer (B); and
starting from mixing Component I and Component II, the Shore D hardness of the composition after m hours Hₜ₌ₘ should satisfy the condition: Hₜ₌₂₄ is no less than 70, preferably Hₜ₌₅≥80%*Hₜ₌₂₄, more preferably Hₜ₌₃≥70%*Hₜ₌₂₄, even more preferably Hₜ₌₂≥50%*Hₜ₌₂₄.

30. The composition according to claim 29, wherein the composition has a tensile strength of no less than 7 Mpa and an elongation rate of no less than 1%.

31. The composition according to claim 29, wherein the composition has an adhesive bonding of at least 2 N/mm².

32. The composition according to claim 29, wherein the composition has a gel time of no more than 30 min.

33. The composition according to claim 29, wherein R₁ and R₂ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C18-aryl, C6-C18-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C15-alkenyl and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S;
R₃ and R₄ are in each case independently selected from the group consisting of C1-C10-alkyl, C2-C10-alkenyl, C3-C10-cyclolalkyl, C2-C10-heterocyclyl, C2-C10-heterocyclyl-C1-C10-alkyl, C6-C10-aryl, C6-C10-aryl-C1-C10-alkyl, C2-C10-heteroaryl, C2-C10-heteroaryl-C1-C10-alkyl, C1-C10-alkoxy-C1-C10-alkyl, halo-C1-C10-alkyl, halo-C2-C10-alkenyl, and halo-C3-C10-cyclolalkyl, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S;
n is an integer from 1 to 15;
R₅, if n=1 is, or if n>1 are in each case independently, selected from the group consisting of C1-C10-alkylene, C2-C10-alkenylene, C2-C10-alkynylene, C6-C18-arylene, C3-C10-cyclolalkylene, C5-C10-cyclolalkenylene, C5-C10-cyclolalkynylene, C2-C10-heterocyclylene, and C2-C10-heteroarylene, each of which radicals is optionally substituted by at least one radical selected from the group consisting of halogen, hydroxyl, nitro, cyano, C1-C10-alkyl, C2-C10-alkenyl, C2-C10-alkynyl, C1-C10-alkoxy, C3-C10-cyclolalkyl, C2-C10-heterocyclyl, C2-C10-heterocyclyl-C1-C10-alkyl, halo-C1-C10-alkyl, halo-C3-C10-cyclolalkyl, C6-C10-aryl, C6-C10-aryl-C1-C10-alkyl, C2-C10-heteroaryl, C3-C10-cyclolalkenyl, and C3-C10-cyclolalkynyl, the heteroatom being selected from N, O and S.

34. The composition according to claim 29, wherein R₁ and R₂ are in each case independently selected from the group consisting of C1-C6-alkyl, C2-C6-alkenyl, C3-C6-cyclolalkyl, C3-C6-heterocyclyl, C3-C6-heterocyclyl-C1-C6-alkyl, C6-C8-aryl, C6-C8-aryl-C1-C6-alkyl, C2-C8-heteroaryl, C2-C8-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkynyl, the heteroatom being selected from N, O and S;
R₃ and R₄ are in each case independently selected from the group consisting of C1-C6-alkyl, C2-C6-alkenyl, C3-C6-cyclolalkyl, C3-C6-heterocyclyl, C33-C6-heterocyclyl-C1-C6-alkyl, C6-C8-aryl, C6-C8-aryl-C1-C6-alkyl, C2-C8-heteroaryl, C2-C8-heteroaryl-C1-C6-alkyl, C1-C6-alkoxy-C1-C6-alkyl, halo-C1-C6-alkyl, halo-C2-C6-alkenyl, and halo-C3-C6-cyclolalkyl, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkynyl, the heteroatom being selected from N, O and S;
n is an integer from 1 to 10;
R₅, if n=1 is, or if n>1 are in each case independently, selected from the group consisting of C1-C6-alkylene, C2-C6-alkenylene, C2-C6-alkynylene, C6-C8-arylene, C3-C6-cyclolalkylene, C5-C6-cyclolalkenylene, C5-C6-cyclolalkynylene, C2-C6-heterocyclylene, and C3-C6-heteroarylene, each of which radicals is optionally substituted by at least one radical selected from the group consisting of halogen, hydroxyl, nitro, cyano, C1-C6-alkyl, C2-C6-alkenyl, C2-C6-alkynyl, C1-C6-alkoxy, C3-C6-cyclolalkyl, C2-C6-heterocyclyl, C2-C6-heterocyclyl-C1-C6-alkyl, halo-C1-C6-alkyl, halo-C3-C6-cyclolalkyl, C6-C8-aryl, C6-C8-aryl-C1-C6-alkyl, C2-C8-heteroaryl, C3-C6-cyclolalkenyl, and C3-C6-cyclolalkyny, the heteroatom being selected from N, O and S, wherein R₅ is optionally interrupted by a radical selected from N, O and S.

35. The composition according to claim 29, wherein R₁ and R₂ are in each case independently selected from the group consisting of C1-C6-alkyl, C3-C6-cyclolalkyl;
R₃ and R₄ are in each case independently selected from the group consisting of C1-C6-alkyl;
n is an integer from 1 to 8; and
R₅, if n=1 is, or if n>1 are in each case independently, selected from the group consisting of C1-C6-alkylene and C6-C8-arylene, each of which radicals is optionally substituted by at least one C1-C6-alkyl.

36. The composition according to claim 29, wherein the acidic stabilizer (C) is at least one selected from sulfuric acid (H₂SO₄), trifluoromethane sulfonic acid (TFA), chlorodifluoro acid, maleic acid, methane sulfonic acid (MSA), p-Toluenesulfonic acid (p-TSA), difluoro acetic acid, trichloroacetic acid, phosphoric acid, dichloroacetic acid and a mixture thereof.

37. The composition according to claim 29, wherein the alkali accelerator is at least one selected from a base, a base precursor, or a base enhancer.

38. The composition according to claim 29, wherein the alkali accelerator is at least one selected from aliphatic monoamines, aliphatic diamines, aliphatic triamines, aliphatic oligomer, aromatic amines, etheramines, hydramines, polyurethane catalyst, morpholines, piperidines, piperazines, pyridines, nitro compounds, metal or amine salts of organic lewis acids, preferably, salts of polymer bound acids, 2,4-pentanedionate, diketones, monocarboxylic acids, polyacrylic acid co-polymers, preferably, benzoate salts, propionate salts, salts of amine or metal with mineral acids, preferably, halide, silicate, acetate, chloracetate, metal hydroxide, metal oxide, wherein said metal is preferably at least one selected from lithium, sodium, potassium, magnesium, calcium, copper, iron, zinc, aluminum, and cobalt etc.

39. The composition according to claim 29, wherein the alkali accelerator is at least one selected from 2-ethylhexylamine, N-Octylamine, tridecylamine mixture of isomers, 3,3′-dimethyl-4,4′-diaminodicyclohexylmethane, 4,4′-diaminodicyclohexylmethane, isophorone diamine, neopentanediamine (2,2-Dimethylpropane-1,3-diamine), octamethylenediamine, polyetheramine D 2000, polyetheramine D 230, polyetheramine D 400, polyetheramine T 403, polyetheramine T 5000, 4,4′-diaminodiphenylmethane, benzylamine, dibutylethanolamine, di-(2-ethylhexyl)amine, dibutylamine, dicyclohexylamine, ditridecylamine mixture of isomers, 4,9-Dioxadodecane-1,12-diamine, di-(2-methoxyethyl)amine, N,N-dimethylcyclohexylamine, tributylamine, tripropylamine, tris-(2-ethylhexyl)amine, triethylamine, 2-(diisopropylamino)ethylamine, tetramethyl-1,6-hexanediamine, pentamethyldietylenetriamine, bis(2-dimethylaminoethyl) ether, trimethylaminoethylethanolamine, tris(dimethylaminomethyl)phenol, 2-dimethylaminomethylphenol, dimethylethylamine, dimethylpropylamine, N,N-dimethylisopropylamine, N-Ethyldiisopropylamine, trimethylamine, 3-(cyclohexylamino)propylamine, diethylenetriamine, dipropylene triamine, N3-Amine 3-(2-Aminoethylamino)propylamine, N4-Amine N,N′-Bis-(3-Aminopropyl)ethylenediamine, N,N-Bis-(3-aminopropyl)methylamine, 3-(diethylamino)propylamine, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine; 3-dimethylaminopropane-1-ol, dimethylaminoethoxyethanol, diethanol-para-toluidine, diisopropanol-p-toluidine, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene, N-methylmorpholine, 4-(2-hydroxyethyl)morpholine, 2,2′-Dimorpholinodiethylether, 1,8-diazabicyclo-5,4,0-undecene-7, sodium hydroxide, potassium hydroxide, zinc hydroxide, copper hydroxide, magnesium hydroxide, aluminum hydroxide, calcium hydroxide, ferric and ferrous hydroxide, sodium benzoate, lithium chloride, sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, sodium silicate, potassium silicate, zinc silicate, copper silicate, magnesium silicate, iron silicate and aluminum silicate.

40. The composition according to claim 29, wherein the alkali accelerator is at least one selected from sodium silicate, potassium silicate, zinc silicate, copper silicate, magnesium silicate, aluminum silicate, dimethylethylamine, dimethylpropylamine, N,N-dimethylisopropylamine, N-Ethyldiisopropylamine, N,N-dimethylcyclohexylamine, trimethylamine, triethylamine, tripropylamine, tributylamine, tris-(2-ethylhexyl)amine, 2-(diisopropylamino)ethylamine, tetramethyl-1,6-hexanediamine, S-triazine, pentamethyldietylenetriamine, bis(2-dimethylaminoethyl) ether, N,N-Dimethylcyclohexylamine, bis(2-dimethylaminoethyl)ether, pentamethyldietylenetriamine, trimethylaminoethylethanolamine, tetramethyl-1,6-hexanediamine, tris(dimethylaminomethyl)phenol, 2-dimethylaminomethylphenol, butyldiethanolamine, triisopropanolamine, diethylethanolamine, methyldiethanolamine, methyldiisopropanolamine, N,N-dimethylethanolamine S, N,N-dimethylisopropanolamine, dimethylethanolamine, N,N,N′,N′-Tetrakis(2-hydroxyethyl)ethylenediamine; dimethylaminoethoxyethanol, diethanol-para-toluidine, diisopropanol-p-toluidine, 3-dimethylaminopropane-1-ol, 2,6-xylidine, 2-phenylethylamine, aniline, N-(2-hydroxyethyl)aniline, N,N-di-(2-hydroxyethyl)aniline, N-ethyl-N-(2-hydroxyethyl)aniline, o-toluidine, p-nitrotoluene, lithium chloride, piperidene, piperazine, N-Methylmorpholine, 4-(2-hydroxyethyl)morpholine, 2,2′-Dimorpholinodiethylether, pyridine at a concentration of 0.03-5%.

41. The composition according to claim 29, wherein the alkali accelerator is at least one selected from sodium propionate, potassium propionate, zinc propionate, copper propionate, magnesium propionate, aluminum propionate, sodium sorbate, potassium sorbate, zinc sorbate, copper sorbate, magnesium sorbate, aluminum sorbate, sodium benzoate, potassium benzoate, zinc benzoate, copper benzoate, magnesium benzoate, aluminum benzoate, 2-ethylhexylamine, N-Octylamine, tridecylamine, 3,3′-dimethyl-4,4′-diaminodicyclohexylmethane, 4,4′-diaminodicyclohexylmethane, isophorone diamine, neopentanediamine, 2,2-Dimethylpropane-1,3-diamine, octamethylenediamine, dibutylethanolamine, 4,4′-diaminodiphenylmethane, benzylamine, polyetheramine D 2000, polyetheramine D 230, polyetheramine D 400, polyetheramine T 403, polyetheramine T 5000, di-(2-ethylhexyl)amine, dibutylamine, dicyclohexylamine, ditridecylamine, 4,9-Dioxadodecane-1,12-diamine, di-(2-methoxyethyl)amine, 3-(cyclohexylamino)propylamine, diethylenetriamine, dipropylene triamine, N3-Amine (3-(2-Aminoethylamino)propylamine), N4-Amine (N,N′-Bis-(3-Aminopropyl)ethylenediamine), 3-(diethylamino)propylamine, N,N-Bis-(3-aminopropyl)methylamine, diketone at a concentration of 0.5-30%.

42. The composition according to claim 29, wherein the alkali accelerator is at least one selected from sodium hydroxide, potassium hydroxide, zinc hydroxide, copper hydroxide, magnesium hydroxide, aluminum hydroxide, calcium hydroxide, sodium oxide, potassium oxide, zinc oxide, copper oxide, magnesium oxide, aluminum oxide, calcium oxide, sodium acetate, potassium acetate, zinc acetate, copper acetate, magnesium acetate, aluminum acetate, sodium chloracetate, potassium chloracetate, copper chloracetate, zinc chloracetate, magnesium chloracetate, aluminum chloracetate, ammonium salts, amine salts at a concentration of 5-100%.

43. The composition according to claim 29, wherein the alkali accelerator is at least one selected from lithium chloride, tris(dimethylaminomethyl)phenol, 2-dimethylaminomethylphenol, diethylenetriamine, N,N,N′,N′-Tetrakis(2-hydroxyethyl)ethylenediamine at a concentration of 0.03-1%.

44. The composition according to claim 29, wherein the alkali accelerator is at least one selected from sodium propionate, sodium benzoate, 2,2′-Dimorpholinodiethylether at a concentration of 1-35%.

45. The composition according to claim 29, wherein the alkali accelerator is at least one selected from calcium hydroxide, magnesium oxide, Manganese acetylacetonate, tetrabutyl ammonium chloride, tetrabutyl ammonium hydroxide at a concentration of 35-100%.

46. The composition according to claim 29, wherein the composition includes two independent packages of Component I and Component II that may be mixed on the spot for applications of the composition.

47. A composition according to according to claim 29, wherein the composition further comprises at least one optional additive selected from the group consisting of dyes, pigments, toughening agents, impact modifiers, rheology modifiers, plasticizing agents, thixotropic agents, natural or synthetic rubbers, filler agents, reinforcing agents, thickening agents, opacifiers, inhibitors, fluorescence or other markers, thermal degradation reducers, thermal resistance conferring agents, defoaming agents, surfactants, wetting agents, dispersants, flow or slip aids, biocides, and stabilizers.

48. A mixture comprising the composition according to claim 29.

49. The mixture according to claim 48, wherein the mixture is substantially absence of any solvent.

50. A process for preparing the composition according to claim 29 comprising steps of:
(1) mixing the monomer (A), the polymer (B) and the acidic stabilizer (C) to obtain Component I;
(2) preparing the Component II; and
(3) mixing the Component I, the Component II to obtain the composition
